(19) United States
(12) Patent Application Publication
(10) Pub. No.: US 2026/0230403 A1
(43) Pub. Date: Aug. 6, 2026

(54) AI-BASED SYSTEM AND METHOD FOR AUTOMATICALLY PROVIDING ADAPTIVE SECURITY POSTURE RECOMMENDATIONS USING DYNAMIC KNOWLEDGE GRAPHS

(71) Applicant: xFabric Security Inc, Redmond, WA (US)

(72) Inventors: S M Mahbub Murshed, Bothell, WA (US); S M Hasibul Haque, Redmond, WA (US); Ryan Matthew Turner, Seattle, WA (US); Raida Karim, Seattle, WA (US); Hari Vamsi Yadavalli, Sunnyvale, CA (US)

(21) Appl. No.: 19/460,380

(22) Filed: Jan. 27, 2026

Related U.S. Application Data
(60) Provisional application No. 63/750,316, filed on Jan. 28, 2025.

(51) Int. Cl. H04L 41/16; G06F 40/289; G06N 5/022; G06N 20/00; H04L 9/40

(52) U.S. Cl. CPC H04L 41/16; G06F 40/289; G06N 5/022; G06N 20/00; H04L 63/1433

(57) ABSTRACT

An AI-based system and method for automatically providing adaptive security posture recommendations using dynamic knowledge graphs are disclosed. The AI-based system initially obtains infrastructure data from data sources. The AI-based system further generates the dynamic knowledge graphs in real-time based on the obtained infrastructure data by scanning cloud APIs. The AI-based system further retrieves relevant elements from the generated dynamic knowledge graphs, by performing semantic searches within vector databases based on one or more graph queries. The AI-based system further generates the adaptive security posture recommendations based on the retrieved relevant elements using a large language model (LLM). The AI-based system automatically provides the generated adaptive security posture recommendations, as an output, to users through user interfaces associated with electronic devices of the users. The AI-based system further conducts comprehensive security assessments, identifies potential risks, and ensures compliance with one or more industry standards.

### CROSS REFERENCE TO RELATED APPLICATION(S)

This application claims the priority to incorporate by reference the entire disclosure of U.S. provisional patent application No. 63/750,316 filed on January 28, 2025, titled “SYSTEM AND METHOD FOR PROVIDING ADAPTIVE SECURITY POSTURE RECOMMENDATIONS USING DYNAMIC KNOWLEDGE GRAPHS”.

### TECHNICAL FIELD

Embodiments of the present disclosure relate to artificial intelligence security monitoring systems and more particularly relate to an artificial intelligence based (AI-based) system and method for automatically providing one or more adaptive security posture recommendations using one or more dynamic knowledge graphs.

### BACKGROUND

In a realm where organizations are increasingly relying on complex hybrid and multi-cloud environments to support digital transformation, a need for robust cybersecurity solutions has never been more critical. The complex hybrid and multi-cloud environments are composed of numerous interconnected components, from cloud services and applications to one or more DevOps tools and one or more databases, creating a vast and dynamic landscape. As security threats grow in sophistication, it becomes increasingly difficult for the organizations to understand security posture comprehensively. Traditional methods of securing cloud infrastructures fall short, as the traditional methods struggle to provide real-time, context-aware one or more security posture recommendations that may adapt to the constantly changing configurations and emerging risks.

Several prior arts have attempted to tackle the problem of cybersecurity in the complex hybrid and multi-cloud environments, but the prior arts face significant limitations. As shown in FIG. 1, a cloud threat management system 100 provides threat detection and security posture management across one or more cloud platforms such as Amazon Web Services^{®} (AWS^{®}), Google Cloud Platform^{®} (GCP^{®}), and Azure^{®}. While effective for threat detection, the cloud threat management system 100 falls short in providing deep contextual analysis and actionable, tailored one or more security posture recommendations for managing security risks. The focus of the cloud threat management system 100 is primarily on identifying threats, rather than providing detailed, real-time guidance on addressing vulnerabilities and improving security posture. Furthermore, the cloud threat management system 100 lacks a unified approach for handling the complex relationships between one or more infrastructure components, which is critical for accurate risk assessment.

The traditional methods provide security monitoring within respective ecosystems, but the traditional methods do not provide a multi-cloud perspective. The traditional methods provide isolated reports without considering relationships between configurations. The traditional methods tend to focus on detecting known vulnerabilities and generating alerts, however, the traditional methods do not facilitate deep, relational analysis of how security risks may spread across the entire cloud infrastructure of the organizations. This lack of integration makes it difficult for one or more users to gain a holistic understanding of the security posture and hinders proactive risk management. Additionally, the traditional methods are overwhelmed with raw data and the alerts, leading to alert fatigue and making it harder for security teams to prioritize responses. The traditional methods fail to deliver continuous, dynamic assessments of the security posture.

As shown in FIG. 2, a graph processing system 200 provides a solution for querying one or more knowledge graphs using one or more large language models (LLMs) to make complex data accessible. While capabilities of the graph processing system 200 in leveraging the one or more knowledge graphs to analyze data relationships are highly effective, nevertheless, the graph processing system 200 lacks the specialized focus on the cybersecurity and real-time, one or more adaptive security posture recommendations. The graph processing system 200 does not provide one of: the one or more adaptive security posture recommendations and proactive insights specific to infrastructure security needs. The graph processing system 200 may not integrate with real-time changes in security configurations. This limits the effectiveness of the graph processing system 200 in responding to evolving security threats and adapting the one or more security posture recommendations based on the complex hybrid and multi-cloud environments of the organizations.

Therefore, there is a need for an improved AI-based system and method for automatically providing one or more adaptive security posture recommendations using one or more dynamic knowledge graphs. This AI-based system is more advanced, integrated solution that provides real-time, context-aware one or more adaptive security posture recommendations tailored to the specific needs of the complex hybrid and multi-cloud environments, in order to address the above-mentioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a system for providing one or more adaptive security posture recommendations using one or more dynamic knowledge graphs is disclosed.

In an embodiment, an artificial intelligence based (AI-based) method for automatically providing one or more adaptive security posture recommendations using one or more dynamic knowledge graphs, is disclosed. The AI-based method comprises obtaining, by one or more hardware processors, infrastructure data from one or more data sources. The one or more data sources comprise at least one of: one or more cloud providers and one or more development and operations services. The infrastructure data comprise data associated with at least one of: one or more cloud infrastructures and one or more application infrastructures.

The AI-based method further comprises generating, by the one or more hardware processors, the one or more dynamic knowledge graphs in real-time based on the obtained infrastructure data by scanning one or more cloud application programming interfaces (APIs). The one or more dynamic knowledge graphs indicate one or more relationships and dependencies of one or more infrastructure components. The one or more dynamic knowledge graphs comprise one or more nodes indicating each infrastructure component of the one or more infrastructure components and one or more edges indicating the one or more relationships and dependencies of the one or more infrastructure components.

The AI-based method further comprises retrieving, by the one or more hardware processors, one or more relevant elements from the generated one or more dynamic knowledge graphs, by performing one or more semantic searches within one or more vector databases based on one or more graph queries. The AI-based method further comprises generating, by the one or more hardware processors, the one or more adaptive security posture recommendations based on the retrieved one or more relevant elements using a large language model (LLM).

The AI-based method further comprises automatically providing, by the one or more hardware processors, the generated one or more adaptive security posture recommendations, as an output, to one or more users through one or more user interfaces associated with one or more electronic devices of the one or more users.

In an embodiment, the AI-based method further comprising performing, by the one or more hardware processors, one or more operations comprising at least one of: (a) conducting, by the one or more hardware processors, one or more comprehensive security assessments, by: detecting, by the one or more hardware processors, one or more security vulnerabilities comprising one or more unrotated secrets and privilege escalation paths, identifying gaps in compliance, wherein the one or more unrotated secrets refer to one or more security credentials that have not been updated within a pre-determined time period as required by one or more security policies and one or more industry standards, providing, by the one or more hardware processors, clear and actionable step-by-step instructions for addressing one or more detected security issues, and providing, by the one or more hardware processors, one or more real-time security assessments, delivering proactive one or more adaptive security posture recommendations to mitigate one or more risks, and simulating one or more security scenarios to assess potential impact of infrastructure changes, (b) determining, by the one or more hardware processors, whether the one or more infrastructure components are in compliance with the one or more industry standards, by: assessing, by the one or more hardware processors, whether the one or more infrastructure components conform to one or more requirements of the one or more industry standards, and identifying one or more deviations from the regulatory requirements, wherein the one or more industry standards comprise at least one of: National Institute of Standards and Technology (NIST), General Data Protection Regulation (GDPR), and Health Insurance Portability and Accountability Act (HIPAA), and continuously updating, by the one or more hardware processors, compliance status to reflect one or more dynamic shifts in at least one of: the one or more cloud infrastructures and the one or more application infrastructures, and (c) identifying, by the one or more hardware processor, one or more potential risks in at least one of: the one or more cloud infrastructures and the one or more application infrastructures.

In another embodiment, retrieving the one or more relevant elements from the generated one or more dynamic knowledge graphs, comprises: (a) traversing, by the one or more hardware processors, one or more unprocessed nodes of the one or more dynamic knowledge graphs through one or more neighboring nodes; (b) generating, by the one or more hardware processors, a natural language description for each node and each edge of the one or more dynamic knowledge graphs during traversing of the one or more unprocessed nodes, using the LLM, wherein the natural language description incorporates a human-readable description of the one or more nodes and the one or more edges for a structure of the one or more adaptive knowledge graphs; (c) splitting, by the one or more hardware processors, the natural language description of the one or more dynamic knowledge graphs into one or more chunks; (d) generating, by the one or more hardware processors, one or more embedding vectors for each chunk of the one or more chunks, wherein the one or more embedding vectors encode semantic meaning of the natural language description; (e) storing, by the one or more hardware processors, the one or more embedding vectors in one or more vector databases; and (f) performing, by the one or more hardware processors, the one or more semantic searches with the one or more vector databases to retrieve the one or more relevant elements from the generated one or more dynamic knowledge graphs.

In yet another embodiment, generating the one or more adaptive security posture recommendations based on the retrieved one or more relevant elements using the LLM, comprises: (a) receiving, by the one or more hardware processors, one or more queries from the one or more electronic devices associated with the one or more users, wherein the one or more users provide the one or more queries in natural language, making an AI-based system accessible to the one or more users; (b) converting, by the one or more hardware processors, the one or more queries into the one or more graph queries, wherein the one or more graph queries comprise one or more cypher queries possessing one or more specific instructions on what infrastructure data to be retrieved; (c) extracting, by the one or more hardware processors, one or more relevant relationships and entities from the one or more dynamic knowledge graphs based on the one or more graph queries; (d) processing, by the one or more hardware processors, the one or more graph queries to extract the one or more relevant elements; (e) synthesizing, by the one or more hardware processors, the one or more adaptive security posture recommendations based on real-time infrastructure data and one or more insights using the LLM; and (f) generating, by the one or more hardware processors, the one or more adaptive security posture recommendations that are broken into one or more simple insights for adapting the one or more adaptive security posture recommendations to be understandable for the one or more users.

In yet another embodiment, the AI-based method further comprising automatically learning, by the one or more hardware processors, from one or more remediation actions and telemetry data to continuously refine the one or more adaptive security posture recommendations for improving accuracy of the LLM over time, by: (a) collecting, by the one or more hardware processors, the one or more remediation actions taken by the one or more users in response to the one or more adaptive security posture recommendations; wherein the one or more remediation actions comprise at least one of: one or more steps taken to address detected security issues, compliance gaps, and misconfigurations within at least one of: the one or more cloud infrastructures and the one or more application infrastructures; (b) continuously collecting, by the one or more hardware processors, the telemetry data from at least one of: the one or more cloud infrastructures and the one or more application infrastructures, wherein the telemetry data comprises at least one of: real-time operational metrics, security events, configuration changes, and performance indicators associated with the one or more infrastructure components; (c) analyzing, by the one or more hardware processors, effectiveness of the one or more remediation actions by correlating the one or more remediation actions with subsequent changes in the telemetry data, wherein the analysis determines whether the one or more remediation actions successfully resolved the detected security issues and improved the overall one or more security posture recommendations; (d) identifying, by the one or more hardware processors, one or more patterns and correlations between one or more specific remediation actions and outcomes of the one or more specific remediation actions, wherein the one or more patterns indicate which remediation strategies are optimized effective for specific types of security vulnerabilities, compliance gaps, and infrastructure configurations; (e) updating, by the one or more hardware processors, the LLM using the identified one or more patterns and correlations, wherein the LLM is updated to incorporate one or more learned insights, adapting the generation of accurate and context-aware one or more adaptive security posture recommendations; (f) continuously refining, by the one or more hardware processors, the one or more adaptive security posture recommendations based on the accumulated learning of the LLM, wherein the refined one or more adaptive security posture recommendations possess improved accuracy, relevance, and effectiveness in addressing security risks and determining compliance with the one or more industry standards; and (g) identifying, by the one or more hardware processors, refining by reinforcement learning that optimizes a result by taking user feedback and codifying at least one of: self-learning and reinforcement learning into knowledge, for analyzing the effectiveness of the one or more remediation actions.

In yet another embodiment, the AI-based method further comprising simulating and predicting, by the one or more hardware processors, the security risks and potential compliance gaps based on dynamic infrastructure changes, by: (a) creating, by the one or more hardware processors, one or more virtual representations of proposed modifications to the one or more infrastructure components, comprising adding one or more new cloud services, changing configurations, modifying access permissions, and updating the dependencies; (b) analyzing, by the one or more hardware processors, the one or more dynamic knowledge graphs to determine how the proposed modifications affect the one or more relationships and dependencies between the one or more infrastructure components, identifying one or more potential new vulnerabilities; (c) assessing, by the one or more hardware processors, multi-hop impact by determining whether the proposed modifications to the one or more infrastructure components result in deviations from the one or more industry standards comprising internal standards and baseline for identifying the potential compliance gaps before an occurrence of the proposed modifications; and (d) remediating, by the one or more hardware processors, with proactive one or more dynamic security posture recommendations to mitigate identified security risks, adapting the one or more organizations, based on simulation assessments, to make informed decisions about infrastructure changes and implement preventive measures.

In yet another embodiment, the AI-based method further comprising: (a) tracing, by the one or more hardware processors, one or more security incidents to a root cause by analyzing the one or more relationships and dependencies in the one or more dynamic knowledge graphs; and accelerating, by the one or more hardware processors, incident response with context-rich insights, for reducing downtime and associated recovery costs for one or more organizations.

In an aspect, an AI-based system for automatically providing one or more adaptive security posture recommendations using one or more dynamic knowledge graphs, is disclosed. The AI-based system comprises one or more hardware processors and a memory. The memory is coupled to the one or more hardware processors. The memory comprises a plurality of subsystems in form of programmable instructions executable by the one or more hardware processors.

The plurality of subsystems comprises a data obtaining subsystem configured to obtain infrastructure data from one or more data sources. The one or more data sources comprise at least one of: one or more cloud providers and one or more development and operations services. The infrastructure data comprise data associated with at least one of: one or more cloud infrastructures and one or more application infrastructures.

The plurality of subsystems further comprises a knowledge graph generating subsystem configured to generate the one or more dynamic knowledge graphs in real-time based on the obtained infrastructure data by scanning one or more cloud application programming interfaces (APIs). The one or more dynamic knowledge graphs indicate one or more relationships and dependencies of one or more infrastructure components. The one or more dynamic knowledge graphs comprise one or more nodes indicating each infrastructure component of the one or more infrastructure components and one or more edges indicating the one or more relationships and dependencies of the one or more infrastructure components.

The plurality of subsystems further comprises an information retrieving subsystem configured to retrieve one or more relevant elements from the generated one or more dynamic knowledge graphs, by performing one or more semantic searches within one or more vector databases based on one or more graph queries. The plurality of subsystems further comprises a recommendation generating subsystem configured to generate the one or more adaptive security posture recommendations based on the retrieved one or more relevant elements using a large language model (LLM).

The plurality of subsystems further comprises an output subsystem configured to automatically provide the generated one or more adaptive security posture recommendations, as an output, to one or more users through one or more user interfaces associated with one or more electronic devices of the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram of a cloud threat management system, in accordance with an embodiment of the prior art;

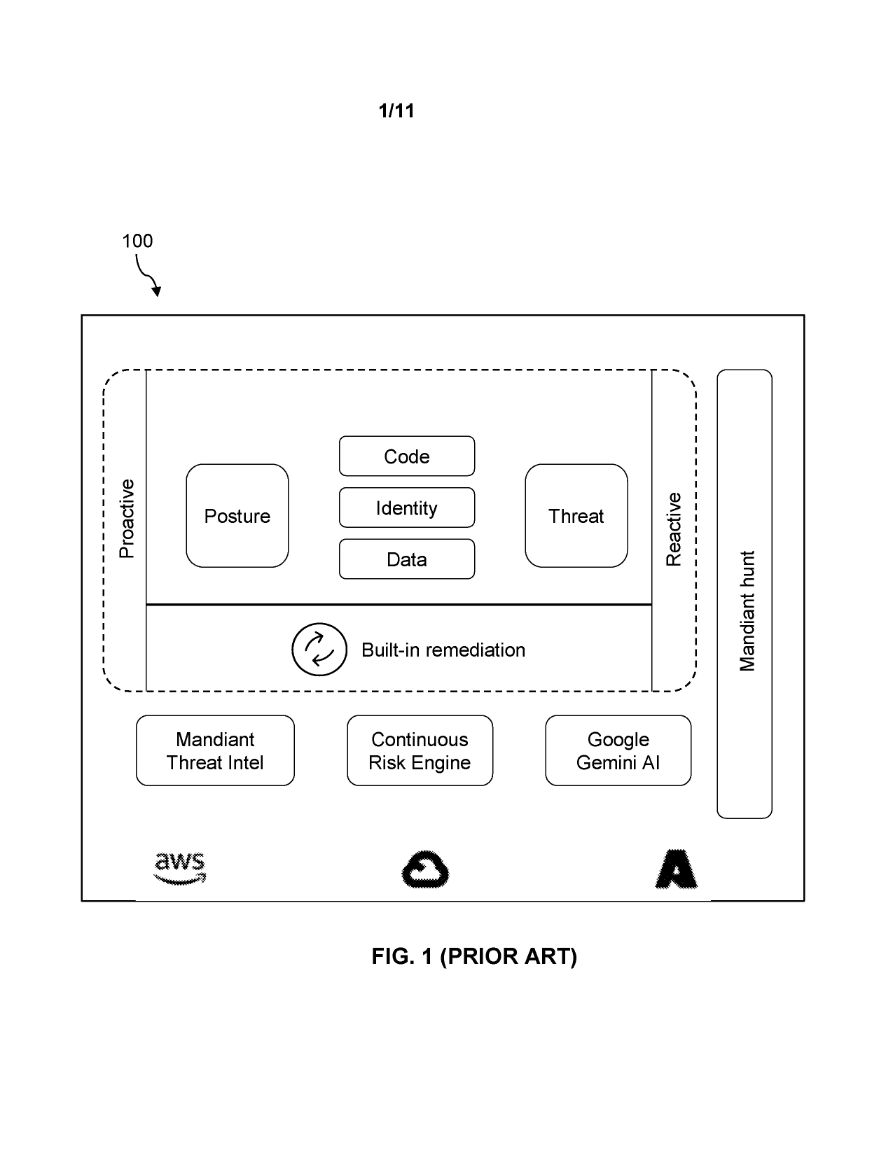

FIG. 2 illustrates an exemplary block diagram representation of a graph processing system, in accordance with an embodiment of the prior art;

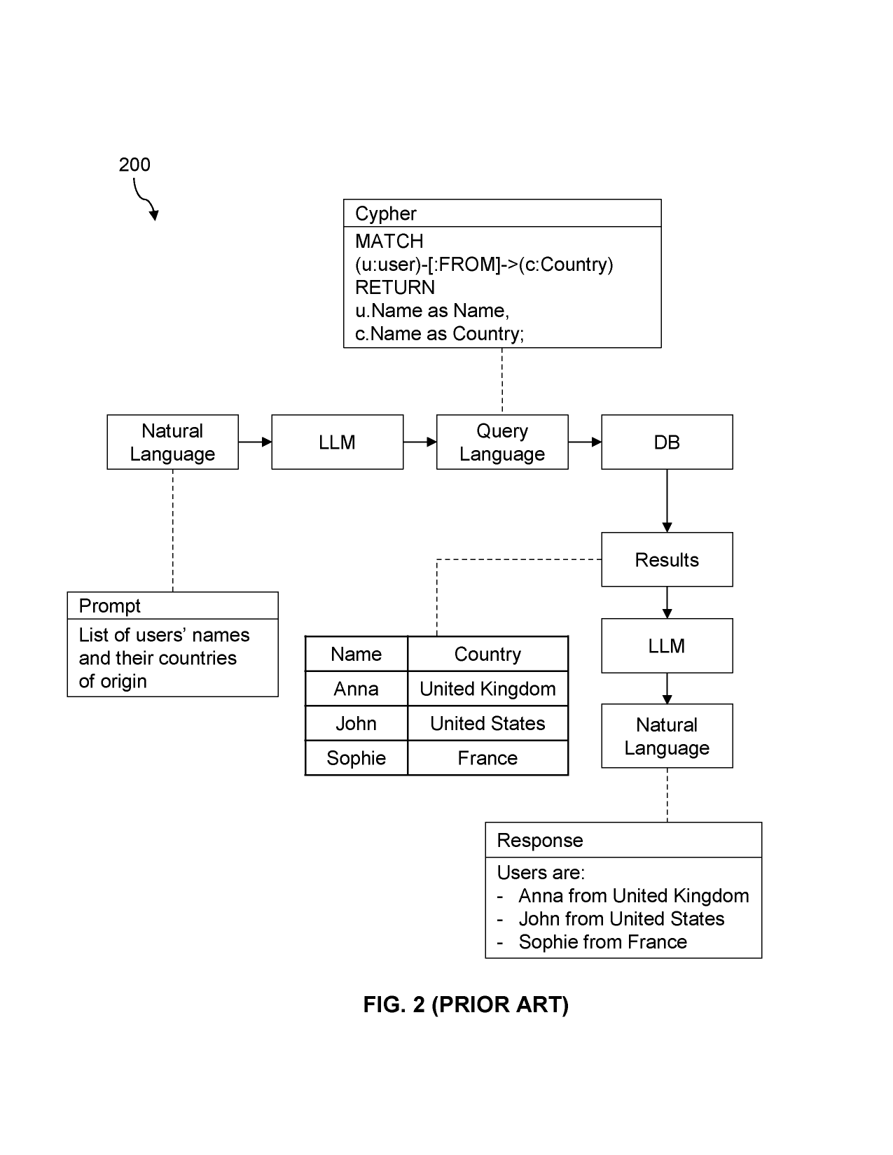

FIG. 3 illustrates an exemplary block diagram representation of a network architecture depicting an artificial intelligence based (AI-based) system for automatically providing one or more adaptive security posture recommendations using one or more dynamic knowledge graphs, in accordance with an embodiment of the present disclosure;

FIG. 4 illustrates an exemplary detailed block diagram representation of the system as shown in FIG. 3 for automatically providing the one or more adaptive security posture recommendations using the one or more dynamic knowledge graphs, in accordance with an embodiment of the present disclosure;

FIG. 5 illustrates an exemplary flow diagram representation depicting the generation of the one or more adaptive security posture recommendations using the one or more dynamic knowledge graphs without one or more custom policies, in accordance with an embodiment of the present disclosure;

FIG. 6 illustrates an exemplary flow diagram representation depicting the generation of the one or more adaptive security posture recommendations without semantic search method and the one or more custom policies, in accordance with an embodiment of the present disclosure;

FIG. 7 illustrates an exemplary visual representation depicting a user interface associated with one or more electronic devices, in accordance with an embodiment of the present disclosure;

FIG. 8 illustrates an exemplary visual representation depicting a user interface associated with the one or more custom policies, in accordance with an embodiment of the present disclosure;

FIG. 9 illustrates an exemplary flow diagram representation depicting a custom policy architecture with the generation of the one or more adaptive security posture recommendations using the one or more dynamic knowledge graphs with the one or more custom policies, in accordance with an embodiment of the present disclosure;

FIG. 10 illustrates an exemplary flow diagram representation depicting the custom policy architecture with the generation of the one or more adaptive security posture recommendations with the one or more custom policies and without semantic search method, in accordance with an embodiment of the present disclosure; and

FIG. 11 is a flow chart illustrating an AI-based method for automatically providing the one or more adaptive security posture recommendations using the one or more dynamic knowledge graphs, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises… a" does not, without more constraints, preclude the existence of other devices, sub-systems, additional sub-modules. Appearances of the phrase "in an embodiment”, "in another embodiment" and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

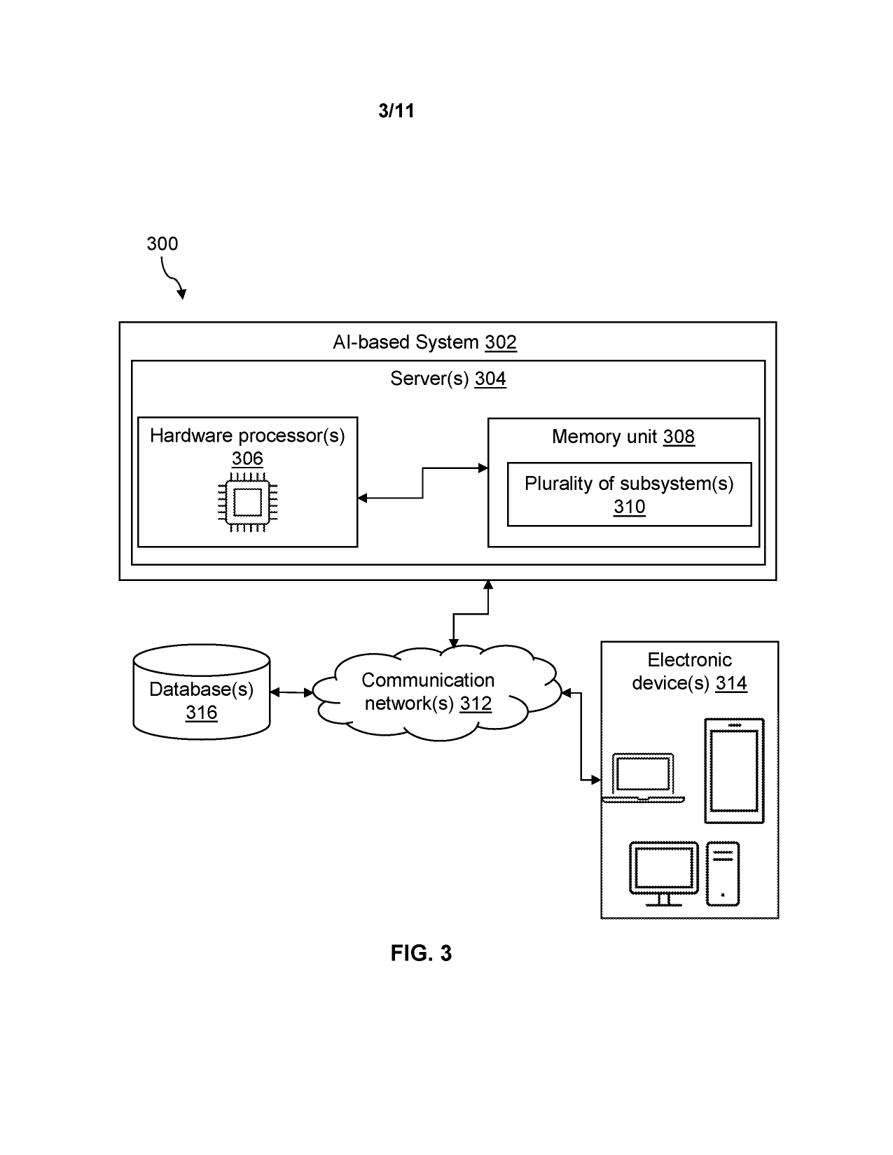

Referring now to the drawings, and more particularly to FIG. 3 through FIG. 11, where similar reference characters denote corresponding features consistently throughout the figures, there are shown preferred embodiments and these embodiments are described in the context of the following exemplary system and/or method.

FIG. 3 illustrates an exemplary block diagram representation of a network architecture 300 depicting an artificial intelligence based (AI-based) system 302 for automatically providing one or more adaptive security posture recommendations using one or more dynamic knowledge graphs, in accordance with an embodiment of the present disclosure.

According to an exemplary embodiment of the present disclosure, the network architecture 300 may include the AI-based system 302, one or more databases 316, and one or more electronic devices 314. The AI-based system 302, the one or more databases 316, and the one or more electronic devices 314 may be communicatively coupled via one or more communication networks 312, ensuring seamless data transmission, processing, and decision-making. The AI-based system 302 acts as a central processing unit within the network architecture 300, responsible for providing the one or more adaptive security posture recommendations using the one or more dynamic knowledge graphs. The AI-based system 302 is configured to execute a set of computer-readable instructions that control a plurality of subsystems 310.

The AI-based system 302 is configured to automatically provide the one or more adaptive security posture recommendations using the one or more dynamic knowledge graphs. The AI-based system 302 is initially configured to obtain infrastructure data from one or more data sources (i.e., the one or more databases 316). In an embodiment, the one or more data sources may be one or more cloud based data sources and one or more non-cloud based data sources (e.g., Kubernetes). The one or more data sources may include at least one of: one or more cloud providers and one or more development and operations services. The infrastructure data may include data associated with at least one of: one or more cloud infrastructures and one or more application infrastructures.

The AI-based system 302 is further configured to generate the one or more dynamic knowledge graphs in real-time based on the obtained infrastructure data by scanning one or more cloud application programming interfaces (APIs). The one or more dynamic knowledge graphs indicate one or more relationships and dependencies of one or more infrastructure components. The one or more dynamic knowledge graphs comprise one or more nodes indicating each infrastructure component of the one or more infrastructure components and one or more edges indicating the one or more relationships and dependencies of the one or more infrastructure components.

The AI-based system 302 is further configured to retrieve one or more relevant elements from the generated one or more dynamic knowledge graphs, by performing one or more semantic searches within one or more vector databases based on one or more graph queries. The AI-based system 302 is further configured to generate the one or more adaptive security posture recommendations based on the retrieved one or more relevant elements using a large language model (LLM). The AI-based system 302 is further configured to provide the generated one or more adaptive security posture recommendations, as an output, to one or more users through one or more user interfaces associated with the one or more electronic devices 314 of the one or more users.

In an exemplary embodiment, the AI-based system 302 comprises one or more servers 304. The one or more servers 304 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or one or more hardware processors 306.

The one or more servers 304 comprise the one or more hardware processors 306 and a memory unit 308 (i.e., a memory). The memory unit 308 is operatively connected to the one or more hardware processors 306. The memory unit 308 comprises a set of computer-readable instructions in the form of the plurality of subsystems 310, configured to be executed by the one or more hardware processors 306.

In an exemplary embodiment, the one or more hardware processors 306 may include, for example, microprocessors, microcomputers, microcontrollers, digital signal processors, central processing units, state machines, logic circuits, and/or any devices that manipulate data or signals based on operational instructions. Among other capabilities, the one or more hardware processors 306 may fetch and execute computer-readable instructions in the memory unit 308 operationally coupled with the AI-based system 302 for performing tasks such as data processing, input/output processing, and/or any other functions. Any reference to a task in the present disclosure may refer to an operation being or that may be performed on data. The one or more hardware processors 306 are high-performance processors capable of handling large volumes of data and complex computations. The one or more hardware processors 306 may be, but not limited to, at least one of: multi-core central processing units (CPU), graphics processing units (GPUs), and the like, that enhance an ability of the AI-based system 302 to process real-time data from one or more sources simultaneously.

In an exemplary embodiment, the one or more databases 316 may configured to store and manage data related to various aspects of the AI-based system 302. The one or more databases 316 may store at least one of, but not limited to, the one or more dynamic knowledge graphs, infrastructure data, any other information necessary for the functionality and optimization of the AI-based system 302, and the like. The one or more databases 316 serve as a centralized repository for critical data elements that are integral to the secure operation of the AI-based system 302, enabling efficient generation of the one or more adaptive security posture recommendations. The one or more databases 316 enable the AI-based system 302 to dynamically retrieve, analyze, and update the stored data in real-time, for generating the one or more adaptive security posture recommendations associated with at least one of: one or more cloud infrastructures and one or more application infrastructures. The one or more databases 316 may include different types of databases such as, but not limited to, relational databases (e.g., Structured Query Language (SQL) databases such as PostgresDB and Oracle^{®} databases), non-Structured Query Language (NoSQL) databases (e.g., MongoDB, Cassandra), time-series databases (e.g., InfluxDB), a graph database, an OpenSearch database, object storage systems (e.g., Amazon^{®} S3), and the like.

In an exemplary embodiment, the one or more electronic devices 314 are configured to enable one or more users to interact with the AI-based system 302. The one or more electronic devices 314 may be digital devices, computing devices, and/or networks. The one or more electronic devices 314 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more electronic devices 314 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more communication networks 312 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth^{®}, ZigBee^{®}, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the AI-based system 302 may be implemented by way of a single device or a combination of multiple devices that may be operatively connected or networked together. The AI-based system 302 may be implemented in hardware or a suitable combination of hardware and software.

Though few components and the plurality of subsystems 310 are disclosed in FIG. 3, there may be additional components and subsystems which is not shown, such as, but not limited to, ports, routers, repeaters, firewall devices, network devices, the one or more databases 316, network attached storage devices, assets, machinery, instruments, facility equipment, emergency management devices, image capturing devices, any other devices, and combination thereof. The person skilled in the art should not be limiting the components/subsystems shown in FIG. 3. Although FIG. 3 illustrates the AI-based system 302, and the one or more electronic devices 314 connected to the one or more databases 316, one skilled in the art can envision that the AI-based system 302, and the one or more electronic devices 314 may be connected to several user devices located at various locations and several databases via the one or more communication networks 312.

Those of ordinary skilled in the art will appreciate that the hardware depicted in FIG. 3 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 302 as is unique to the present disclosure or necessary for an understanding of the present disclosure is depicted and described. The remainder of the construction and operation of the AI-based system 302 may conform to any of the various current implementations and practices that were known in the art.

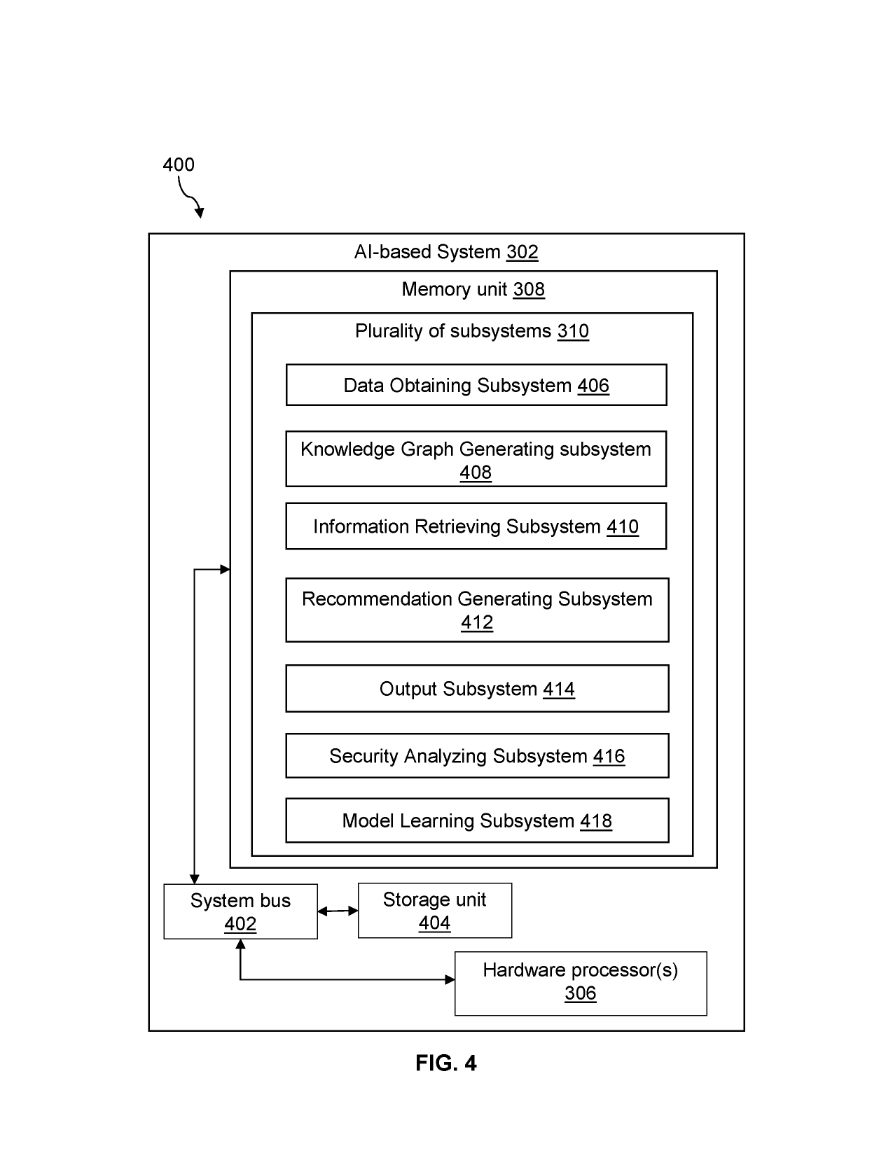

FIG. 4 illustrates an exemplary detailed block diagram representation 400 of the AI-based system 302 as shown in FIG. 3 for automatically providing the one or more adaptive security posture recommendations using the one or more dynamic knowledge graphs, in accordance with an embodiment of the present disclosure.

In an exemplary embodiment, the AI-based system 302 comprises the one or more servers 304, the memory unit 308, and a storage unit 404. The one or more hardware processors 306, the memory unit 308, and the storage unit 404 are communicatively coupled through a system bus 402 or any similar mechanism. The system bus 402 functions as the central conduit for data transfer and communication between the one or more hardware processors 306, the memory unit 308, and the storage unit 404. The system bus 402 facilitates the efficient exchange of information and instructions, enabling the coordinated operation of the AI-based system 302. The system bus 402may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 308 is operatively connected to the one or more hardware processors 306. The memory unit 308 comprises the plurality of subsystems 310 in the form of programmable instructions executable by the one or more hardware processors 306. The plurality of subsystems 310 comprises a data obtaining subsystem 406, a knowledge graph generating subsystem 408, an information retrieving subsystem 410, a recommendation generating subsystem 412, an output subsystem 414, a security analyzing subsystem 416, and a model learning subsystem 418.

The one or more hardware processors 306 associated within the one or more servers 304, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 306 may also include embedded controllers, such as generic or programmable logic devices or arrays, application-specific integrated circuits, single-chip computers, and the like.

The memory unit 308 may be the non-transitory volatile memory and the non-volatile memory. The memory unit 308 may be coupled to communicate with the one or more hardware processors 306, such as being a computer-readable storage medium. The one or more hardware processors 306 may execute machine-readable instructions and/or source code stored in the memory unit 308. A variety of machine-readable instructions may be stored in and accessed from the memory unit 308. The memory unit 308 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 308 includes the plurality of subsystems 310 stored in the form of machine-readable instructions on any of the above-mentioned storage media and may be in communication with and executed by the one or more hardware processors 306.

The storage unit 404 may be a cloud storage or the one or more databases 316 such as those shown in FIG. 3. The storage unit 404 may store, but not limited to, recommended course of action sequences dynamically generated by the AI-based system 302. The action sequences comprise data obtaining, dynamic knowledge graph generation, data/information retrieval, the one or more adaptive security posture recommendations generation, security analysis, and the like. Additionally, the storage unit 404 may retain previous action sequences for comparison and future reference, enabling continuous refinement of the AI-based system 302 over time. The storage unit 404 may be any kind of database such as, but not limited to, relational databases, dedicated databases, dynamic databases, monetized databases, scalable databases, cloud databases, distributed databases, any other databases, and a combination thereof.

The plurality of subsystems 310 includes the data obtaining subsystem 406 that is communicatively connected to the one or more hardware processors 306. The data obtaining subsystem 406 is configured to obtain infrastructure data from one or more data sources (i.e., the one or more databases 316). The one or more data sources may include at least one of: the one or more cloud providers and the one or more development and operations services. The infrastructure data may include the data associated with at least one of: the one or more cloud infrastructures and the one or more application infrastructures.

The data obtaining subsystem 406 is a component of the AI-based system 302, which collects and gathers infrastructure data from various external sources to enable security analysis and recommendations. The infrastructure data is obtained from one or more sources, including, but not restricted to, at least one of: Amazon Web Services^{®} (AWS^{®}), Google Cloud Platform^{®} (GCP^{®}), Azure^{®}, one or more DevOps tools (Hashicorp Vault and Kubernetes), and the like. The one or more cloud providers refer to third-party companies that offer cloud computing services, platforms, and infrastructure over the internet, such as AWS^{®}, GCP^{®}, and Azure^{®}. The development and operations services (DevOps tools) are software tools that facilitate collaboration between development and IT operations teams, such as Hashicorp Vault for secrets management and Kubernetes for container orchestration.

The infrastructure data refers to information about the configuration, state, and relationships of computing resources within an organization's technology environment. By obtaining the infrastructure data, the metadata integration module ensures that the knowledge graph generating subsystem 408 captures a comprehensive view of at least one of: the one or more cloud infrastructures and the one or more application infrastructures. The one or more cloud infrastructures comprise the hardware and software components, such as servers, storage, and networking, that enable cloud computing services. The one or more application infrastructures comprise the underlying framework and components that support the deployment, operation, and management of software applications. For example, the data obtaining subsystem 406 may connect to an organization's AWS account to retrieve data about virtual machines, storage buckets, service accounts, and their configurations, as well as connect to Kubernetes to obtain data about container deployments and access permissions, thereby providing a complete picture of the organization's security landscape.

The plurality of subsystems 310 further includes the knowledge graph generating subsystem 408 that is communicatively connected to the one or more hardware processors 306. The knowledge graph generating subsystem 408 is configured to generate and manage the one or more dynamic knowledge graphs in real-time based on the obtained infrastructure data by scanning one or more cloud application programming interfaces (APIs). The one or more dynamic knowledge graphs indicate one or more relationships and dependencies of one or more infrastructure components, such as, but not constrained to, at least one of: cloud services, configurations, the one or more DevOps tools, and the like.

The knowledge graph generating subsystem 408 ensures that the one or more dynamic knowledge graphs 314 reflect a current state of at least one of: the one or more cloud infrastructures and the one or more application infrastructures, thereby adapting dynamically as changes occur. The one or more dynamic knowledge graphs comprise one or more nodes indicating each infrastructure component of the one or more infrastructure components and one or more edges indicating the one or more relationships and dependencies of the one or more infrastructure components.

The knowledge graph generating subsystem 408 is a component of the AI-based system 302, which constructs and manages the one or more dynamic knowledge graphs based on the obtained infrastructure data. The dynamic knowledge graphs are data structures that visually and logically represent entities and their interconnections, updated in real-time to reflect the current state of the infrastructure. The one or more cloud application programming interfaces (APIs) are standardized interfaces that allow the knowledge graph generating subsystem 408 to programmatically access and retrieve configuration and status information from the one or more cloud platforms.

The one or more infrastructure components are the individual elements that make up an organization's technology environment, including virtual machines, service accounts, data stores, encryption keys, and network configurations. The one or more nodes are the individual points within the dynamic knowledge graph that represent each infrastructure component, while edges are the connecting lines between the one or more nodes that represent the relationships and dependencies between the infrastructure components. The one or more relationships and dependencies describe how infrastructure components interact with and rely upon each other, such as authentication flows, access permissions, and encryption associations.

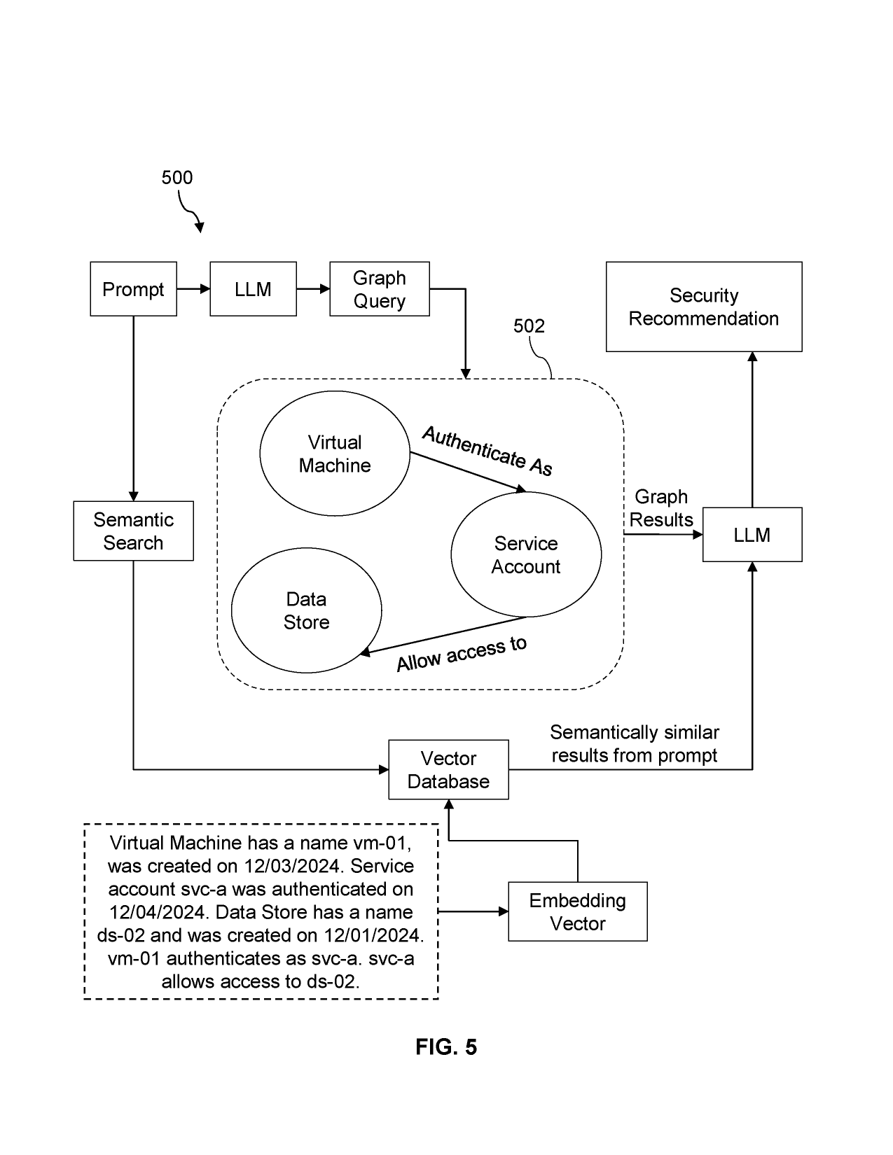

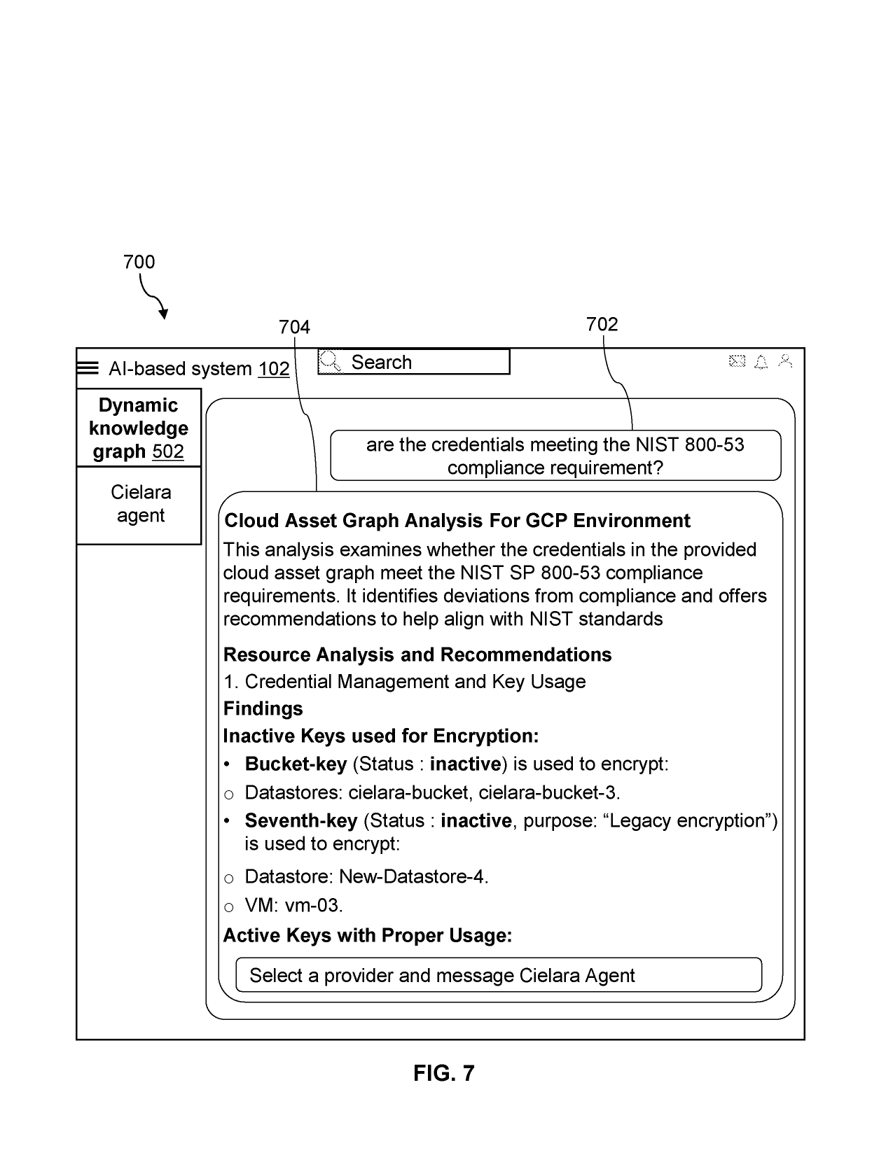

For example, as shown in FIG. 5, the dynamic knowledge graph may contain the one or more nodes representing a Virtual Machine (vm-01), a Service Account (svc-a), and a Data Store (ds-02), with the one or more edges indicating that the Virtual Machine authenticates as the Service Account, and the Service Account allows access to the Data Store. Similarly, FIG. 7 illustrates a knowledge graph showing encryption keys (bucket-key, Seventh-Key) and their relationships to datastores (cielara-bucket, New-Datastore-4) and virtual machines (vm-03), enabling the knowledge graph generating subsystem 408 to identify that inactive keys are being used to encrypt critical resources.

The plurality of subsystems 310 further includes the information retrieving subsystem 410 that is communicatively connected to the one or more hardware processors 306. The information retrieving subsystem 410 is configured to retrieve one or more relevant elements from the generated one or more dynamic knowledge graphs, by performing one or more semantic searches within one or more vector databases based on one or more graph queries. The information retrieving subsystem 410 is a component of the AI-based system 302 that efficiently retrieves the one or more relevant elements from the one or more dynamic knowledge graphs by leveraging semantic search and vector embeddings. The one or more relevant elements are specific nodes, edges, relationships, or data points within the one or more dynamic knowledge graphs that are pertinent to a user's query or security analysis request.

The one or more semantic searches are search operations that go beyond basic keyword matching to retrieve relevant elements based on meaning and context, enabling the information retrieving subsystem 410 to understand the intent behind a query. The one or more vector databases are specialized databases optimized for storing and searching vector embeddings, enabling fast similarity-based searches to find related information efficiently. The one or more graph queries are structured queries, such as cypher queries, that define specific instructions on what data to retrieve from the one or more dynamic knowledge graphs, extracting relevant relationships and entities.

For retrieving the one or more relevant elements from the generated one or more dynamic knowledge graphs, the information retrieving subsystem 410 is initially configured to traverse one or more unprocessed nodes of the one or more dynamic knowledge graphs through one or more neighboring nodes. The information retrieving subsystem 410 with a description generator module is further configured to generate a natural language description for each node and each edge of the one or more dynamic knowledge graphs during traversing of the one or more unprocessed nodes, using the LLM. The natural language description incorporates a human-readable description of the one or more nodes and the one or more edges for a structure of the one or more adaptive knowledge graphs.

The information retrieving subsystem 410 is further configured to split the natural language description of the one or more dynamic knowledge graphs into one or more chunks. The information retrieving subsystem 410 is further configured to generate one or more embedding vectors for each chunk of the one or more chunks. The one or more embedding vectors encode semantic meaning of the natural language description. The information retrieving subsystem 410 is further configured to store the one or more embedding vectors in one or more vector databases. The information retrieving subsystem 410 is further configured to perform the one or more semantic searches with the one or more vector databases to retrieve the one or more relevant elements from the generated one or more dynamic knowledge graphs.

Traversing is the process of systematically visiting each node in the dynamic knowledge graph by moving through connected nodes. The information retrieving subsystem 410 traverses one or more unprocessed nodes of the one or more dynamic knowledge graphs through one or more neighboring nodes. The one or more unprocessed nodes are nodes that have not yet been visited or analyzed, while the one or more neighboring nodes are nodes directly connected via edges representing related infrastructure components. The natural language description is a human-readable textual representation of the graph structure. The information retrieving subsystem 410 generates the natural language description for each node and each edge of the one or more dynamic knowledge graphs during traversing of the one or more unprocessed nodes, using the LLM. The natural language description incorporates a human-readable description of the one or more nodes and the one or more edges for a structure of the one or more adaptive knowledge graphs. This makes the dynamic knowledge graph understandable for both technical and non-technical users.

The one or more chunks are smaller segments created by splitting the natural language description into manageable pieces for efficient processing and embedding generation. The one or more embedding vectors are numerical representations that encode the semantic meaning of the natural language description, allowing the system to understand and compare relationships based on meaning rather than exact keywords. The one or more vector databases are specialized storage systems optimized for storing embedding vectors and performing fast similarity-based searches, enabling the information retrieving subsystem 410 to retrieve the relevant information efficiently.

The one or more semantic searches are search operations optionally performed within the vector databases to find relevant elements based on meaning and context rather than exact keyword matching. In this context, the semantic search is an optional method since having both graph queries and semantic search are not required. Further, in this context, the graph queries method is essential for LLM to understand the context and provide useful analysis, and the semantic search method can be used optionally. For example, when traversing a dynamic knowledge graph, the information retrieving subsystem 410 visits a Virtual Machine node (vm-01), moves to its neighboring Service Account node (svc-a), and then to a Data Store node (ds-02), generating a natural language description such as "Virtual Machine vm-01 authenticates as Service Account svc-a, which allows access to Data Store ds-02." This description is split into chunks, converted into embedding vectors, stored in the vector database, and later retrieved via semantic search when a user queries about authentication relationships or access permissions.

The plurality of subsystems 310 further includes the recommendation generating subsystem 412 that is communicatively connected to the one or more hardware processors 306. The recommendation generating subsystem 412 is configured to interpret the one or more queries and generate the one or more adaptive security posture recommendations based on the retrieved one or more relevant elements using the large language model (LLM). The one or more adaptive security posture recommendations are tailored, context-aware suggestions that help organizations address security vulnerabilities, compliance gaps, and misconfigurations within their cloud and application infrastructures. The Large language model (LLM) is an artificial intelligence model trained on vast amounts of text data that can understand natural language queries, process complex information, and generate human-readable responses and recommendations. The one or more retrieved relevant elements are the specific nodes, relationships, and data points extracted from the dynamic knowledge graphs through semantic searches (optional) and graph queries that provide context for generating recommendations.

For generating the one or more adaptive security posture recommendations based on the retrieved one or more relevant elements using the LLM, the recommendation generating subsystem 412 is initially configured to receive one or more queries from the one or more electronic devices 314 associated with the one or more users, through the one or more user interfaces. The one or more users provide the one or more queries in natural language, making an AI-based system 302 accessible to the one or more users (e.g., one or more non-technical users). The one or more queries are questions or requests submitted by users seeking information about their infrastructure security. The natural language refers to everyday human language that allows non-technical users to interact with the system without requiring specialized query syntax knowledge, making the AI-based system 302 accessible to users regardless of their technical expertise.

The recommendations generating subsystem 310 with a query recognizing module is further configured to convert the one or more queries into the one or more graph queries (cypher query or other types of graph query language such as Cypher, Gremlin, SPARQL, GQL, and the like). The one or more graph queries may include one or more cypher queries possessing one or more specific instructions on what infrastructure data to be retrieved. The one or more graph queries are structured database queries used to extract specific information from knowledge graphs. The cypher query is a specific query language designed for graph databases that enables precise extraction of nodes, edges, and relationships by possessing specific instructions on what infrastructure data to be retrieved.

The recommendations generating subsystem 310 is further configured to extract one or more relevant relationships and entities from the one or more dynamic knowledge graphs based on the one or more graph queries. The relevant relationships and entities are the specific connections and infrastructure components pertinent to the user's query that are extracted from the one or more dynamic knowledge graphs based on the one or more graph queries. The recommendations generating subsystem 310 is further configured to process the one or more graph queries to extract the one or more relevant elements. The relevant elements are the extracted data points, nodes, and relationships that provide context for generating recommendations after processing the one or more graph queries.

The recommendations generating subsystem 310 is further configured to synthesize the one or more adaptive security posture recommendations based on real-time infrastructure data and one or more insights using the LLM. Synthesizing refers to combining and analyzing the extracted information with real-time infrastructure data and insights using the LLM to produce meaningful, context-aware recommendations. The recommendations generating subsystem 310 is further configured to generate the one or more adaptive security posture recommendations that are broken into one or more simple insights for adapting the one or more adaptive security posture recommendations to be understandable for the one or more users. In other words, by leveraging the one or more LLMs, the recommendation generating subsystem 412 is configured to ensure that the one or more adaptive security recommendations are easy to understand for both the one or more technical users and the one or more non-technical users, thereby breaking down complex data into the one or more simple insights. The one or more simple insights are clear, easy-to-understand explanations of complex security findings that break down the adaptive security posture recommendations to be understandable for the one or more users.

For example, when a user submits a natural language query "Are credentials meeting NIST 800-53 compliance requirements?", the recommendation generating subsystem 412 converts this into a cypher query to extract encryption key statuses and their relationships to resources, extracts relevant relationships showing inactive keys (bucket-key, Seventh-Key) connected to critical resources, processes the query to retrieve relevant elements, synthesizes findings using the LLM, and generates a simple insight such as “Two inactive encryption keys are securing critical resources, violating NIST credential management requirements. Immediate key rotation is recommended.”

In an exemplary embodiment, the recommendation generating subsystem 412 is further configured to simulate and predict the security risks and potential compliance gaps based on dynamic infrastructure changes, by: (a) creating one or more virtual representations of proposed modifications to the one or more infrastructure components, comprising adding one or more new cloud services, changing configurations, modifying access permissions, and updating the dependencies; (b) analyzing the one or more dynamic knowledge graphs to determine how the proposed modifications affect the one or more relationships and dependencies between the one or more infrastructure components, identifying one or more potential new vulnerabilities; (c) assessing multi-hop impact by determining whether the proposed modifications to the one or more infrastructure components result in deviations from the one or more industry standards comprising internal standards and baseline for identifying the potential compliance gaps before an occurrence of the proposed modifications; and (d) remediating with proactive one or more dynamic security posture recommendations to mitigate identified security risks, adapting the one or more organizations, based on simulation assessments, to make informed decisions about infrastructure changes and implement preventive measures.

Simulating refers to the process of modeling and assessing potential security risks and compliance gaps that may arise from proposed infrastructure changes before such changes are actually implemented. The security risks are potential threats or vulnerabilities that could compromise the integrity, availability, or confidentiality of the organization's infrastructure. The potential compliance gaps are possible deviations from industry standards such as NIST, GDPR, or HIPAA that may result from proposed changes. The dynamic infrastructure changes are modifications to the cloud and application infrastructures that occur over time, such as adding new services, updating configurations, or changing permissions.

The one or more virtual representations are simulated models of proposed modifications that allow the system to analyze their impact without actually implementing the changes in the live environment. The proposed modifications are planned changes to infrastructure components that have not yet been executed. Adding new cloud services refers to deploying additional cloud resources such as virtual machines, storage buckets, or databases. Changing configurations refers to modifying settings such as encryption methods, network rules, or resource allocations. Modifying access permissions refers to updating who or what can access specific resources and at what privilege level. Updating dependencies refers to changing how infrastructure components rely upon and interact with each other.

Analyzing the one or more dynamic knowledge graphs refers to examining the relationships and dependencies within the graph to understand how proposed changes would affect the overall infrastructure structure. The one or more potential new vulnerabilities are security weaknesses that may be introduced as a result of the proposed modifications, such as new privilege escalation paths or exposed resources.

Assessing deviations refers to evaluating whether the proposed modifications would cause the infrastructure to fall out of compliance with industry standards (comprising the internal standards and the baseline) before the changes are made. The proactive one or more dynamic security posture recommendations are preventive suggestions generated for remediation before issues occur, enabling organizations to address risks in advance. The simulation assessments are the results of the simulated analysis that inform decision-making. The informed decisions are choices made with full understanding of the potential security and compliance implications. The preventive measures are actions taken to avoid security risks and compliance gaps before they materialize.

For example, when an organization proposes adding a new virtual machine (vm-04) that will authenticate using an existing service account (svc-a) and access a datastore (ds-02), the recommendation generating subsystem 412 creates a virtual representation of this change, analyzes the dynamic knowledge graph to determine that svc-a already has broad access permissions creating a potential privilege escalation path, assesses that this configuration would deviate from NIST least-privilege requirements, and generates a proactive recommendation: "Creating vm-04 with svc-a authentication would grant excessive access to ds-02. Create a new service account with limited permissions specific to vm-04's requirements to maintain NIST compliance and reduce attack surface."

In another exemplary embodiment, the recommendation generating subsystem 412 is further configured to: (a) trace one or more security incidents to a root cause by analyzing the one or more relationships and dependencies in the one or more dynamic knowledge graphs; and (b) accelerate incident response with context-rich insights, for reducing downtime and associated recovery costs for one or more organizations. Tracing refers to the process of following the path of a security incident backward through the infrastructure to identify its origin and underlying cause. The one or more security incidents are events that compromise or threaten the security of the organization's infrastructure, such as unauthorized access, data breaches, service disruptions, or malware infections. The root cause is the fundamental underlying reason or source that initiated the security incident, which when addressed, prevents the incident from recurring. Analyzing relationships and dependencies refers to examining how infrastructure components are connected and interact with each other within the dynamic knowledge graphs to understand how an incident propagated through the system.

Accelerating incident response means speeding up the process of detecting, investigating, and resolving security incidents by providing immediate access to relevant information. The context-rich insights are detailed, meaningful information about the security incident that includes the affected components, their relationships, the sequence of events, and potential remediation steps, enabling security teams to quickly understand the full scope of the incident. The downtime is the period during which cloud and application infrastructures are unavailable or non-operational due to the security incident. The recovery costs are the expenses incurred by organizations to restore normal operations after a security incident, including labor, resources, lost revenue, and potential regulatory penalties.

For example, when a data breach is detected in a datastore (ds-02), the recommendation generating subsystem 412 traces the incident through the dynamic knowledge graph, analyzing relationships to discover that an attacker gained access through a compromised service account (svc-a) which was authenticated by a virtual machine (vm-01) with an unrotated credential, identifying the unrotated credential as the root cause. The recommendation generating subsystem 412 then provides context-rich insights showing the complete attack path, affected resources, and recommended remediation steps such as "Immediately revoke svc-a credentials, rotate vm-01 authentication keys, and audit all resources accessed by svc-a," enabling the security team to respond quickly and reduce downtime and recovery costs.

The plurality of subsystems 310 further includes the output subsystem 414 that is communicatively connected to the one or more hardware processors 306. The output subsystem 414 is configured to provide the generated one or more adaptive security posture recommendations, as the output, to the one or more users through the one or more user interfaces associated with the one or more electronic devices 314 of the one or more users. The output subsystem 414 is a component of the AI-based system 302 that delivers the generated one or more adaptive security posture recommendations to the one or more users through accessible interfaces. The one or more adaptive security posture recommendations are tailored, context-aware suggestions generated by the recommendation generating subsystem 412 to help organizations address security vulnerabilities, compliance gaps, and misconfigurations within their cloud and application infrastructures.

The one or more user interfaces are visual displays or interactive screens through which the one or more users can view, interact with, and act upon the security recommendations provided by the recommendation generating subsystem 412. The one or more electronic devices 314 are digital computing devices such as desktop computers, laptops, tablets, smartphones, personal digital assistants (PDAs), and wearable computing devices that enable the one or more users to access and interact with the output subsystem 414. The one or more users may include service providers, customers, administrators, vendors, technicians, specialists, instructors, supervisors, security teams, DevOps teams, governance teams, or any individual or entity responsible for managing and securing cloud and application infrastructures. The output subsystem 414 ensures that the recommendations are presented in a clear, actionable format that is understandable for both technical and non-technical users, enabling them to take immediate remediation actions.

For example, as shown in FIG. 7, when a user queries “Are credentials meeting NIST 800-53 compliance requirements?”, the output subsystem 414 displays the analysis results on the user interface, showing findings such as “Inactive Keys Used for Encryption: bucket-key (Status: inactive) is used to encrypt Datastores: cielara-bucket, cielara-bucket-3” and “Seventh-Key (Status: inactive) is used to encrypt Datastore: New-Datastore-4 and VM: vm-03”, along with corresponding recommendations to address these compliance deviations.

The plurality of subsystems 310 further includes the security analyzing subsystem 416 that is communicatively connected to the one or more hardware processors 306. The security analyzing subsystem 416 is configured to conduct one or more comprehensive security assessments, by: (a) detecting one or more security vulnerabilities comprising one or more unrotated secrets and privilege escalation paths, identifying gaps in compliance; (b) providing clear and actionable step-by-step instructions for addressing one or more detected security issues; and (c) providing one or more real-time security assessments, delivering proactive one or more adaptive security posture recommendations to mitigate one or more risks, and simulating one or more security scenarios to assess potential impact of infrastructure changes.

The security analyzing subsystem 416 is a component of the AI-based system 302 that conducts comprehensive security assessments that are thorough evaluations of the entire cloud and application infrastructure to identify vulnerabilities, misconfigurations, and compliance gaps. The security vulnerabilities are weaknesses or flaws in the infrastructure that could be exploited by attackers to gain unauthorized access or cause harm. The one or more unrotated secrets refer to security credentials such as encryption keys, passwords, API keys, or authentication tokens that have not been updated or changed within a pre-determined time period as required by security policies and industry standards, posing increased security risks due to prolonged exposure. The privilege escalation paths are sequences of permissions or access rights that could allow an attacker or unauthorized user to gain elevated privileges beyond their intended access level, potentially compromising critical resources. The gaps in compliance are deviations or failures to meet the requirements of industry standards such as National Institute of Standards and Technology (NIST), General Data Protection Regulation (GDPR), and Health Insurance Portability and Accountability Act (HIPAA). Step-by-step instructions are clear, actionable guidance provided by the system to help users address and remediate detected security issues in a systematic manner.

The real-time security assessments are continuous evaluations of the infrastructure that provide immediate insights into the current security posture as changes occur. The proactive recommendations are preventive suggestions delivered before security issues escalate into incidents, helping organizations mitigate risks early. Simulating the security scenarios refers to modeling hypothetical infrastructure changes to assess their potential impact on security and compliance before actual implementation. For example, the security analyzing subsystem 416 may detect that an encryption key (Seventh-Key) has been inactive for six months but is still used to encrypt a virtual machine (vm-03), identify this as a compliance gap violating NIST 800-53 requirements, provide step-by-step instructions such as “1. Generate a new active encryption key, 2. Re-encrypt vm-03 with the new key, 3. Decommission Seventh-Key,” and simulate the impact of rotating the key to ensure no service disruptions occur.

The security analyzing subsystem 416 is further configured to determine whether the one or more infrastructure components are in compliance with the one or more industry standards, by: (a) assessing whether the one or more infrastructure components conform to one or more requirements of the one or more industry standards, and identifying one or more deviations from the regulatory requirements, and (b) continuously updating compliance status to reflect one or more dynamic shifts in at least one of: the one or more cloud infrastructures and the one or more application infrastructures. The one or more industry standards comprise at least one of: National Institute of Standards and Technology (NIST), General Data Protection Regulation (GDPR), and Health Insurance Portability and Accountability Act (HIPAA).

Assessing conformance refers to evaluating whether infrastructure components meet the specific requirements defined by the one or more industry standards. The one or more infrastructure components are the individual elements within an organization's technology environment, including virtual machines, service accounts, data stores, encryption keys, access permissions, and network configurations. The one or more industry standards are established guidelines and regulatory requirements that organizations must follow to ensure security, privacy, and proper data handling. National Institute of Standards and Technology (NIST) is a U.S. government agency that develops cybersecurity frameworks such as NIST SP 800-53, which provides guidelines for security controls including credential management, key rotation, and access control. General Data Protection Regulation (GDPR) is a European Union regulation governing data protection and privacy, requiring organizations to implement appropriate security measures to protect personal data and ensure data subject rights. Health Insurance Portability and Accountability Act (HIPAA) is a U.S. regulation establishing standards for protecting sensitive patient health information, requiring healthcare organizations to implement administrative, physical, and technical safeguards. The one or more deviations from regulatory requirements are instances where infrastructure components fail to meet the specified requirements of the one or more industry standards, creating compliance gaps that expose the organization to security risks and potential legal penalties.

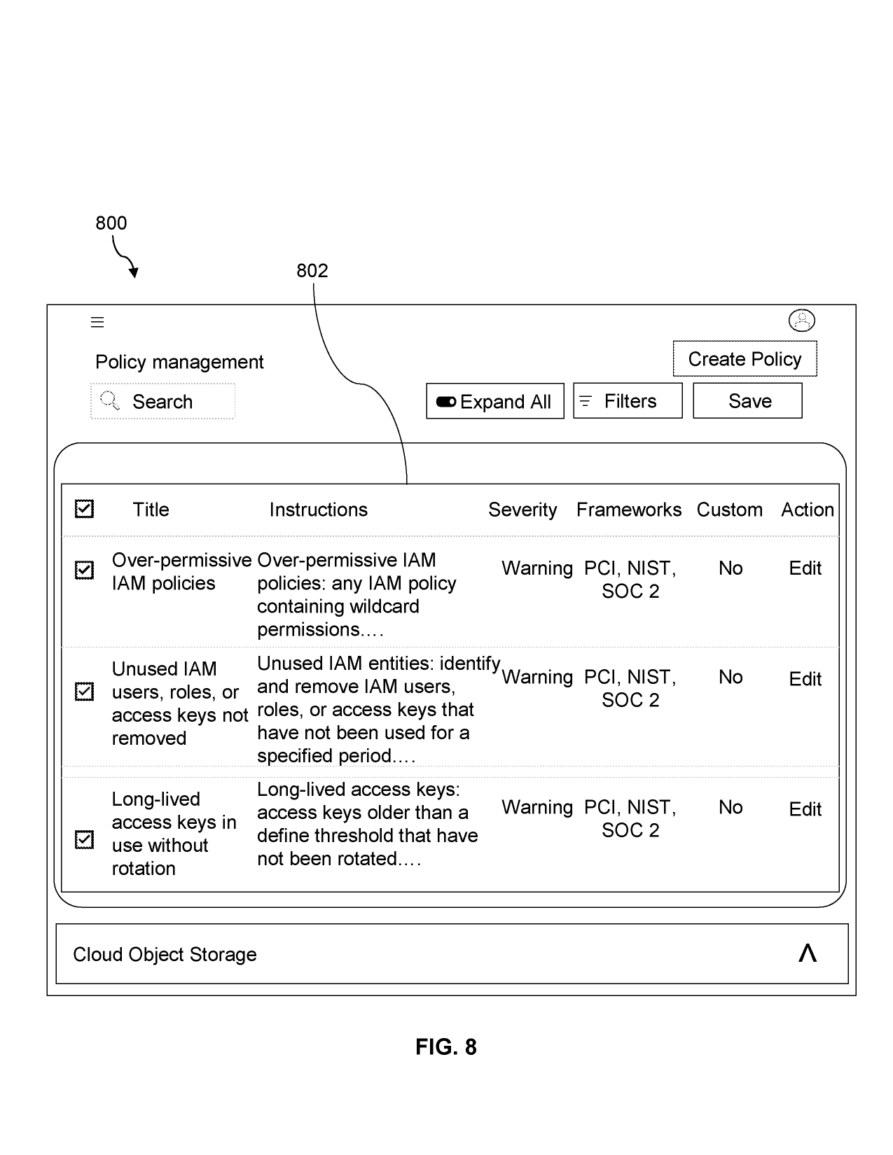

In an embodiment, assessing the conformance refers to evaluating whether infrastructure components meet the specific requirements defined by one or more custom policies. The one or more custom policies can be defined in the UX as list of security check to perform, which can be derived from NIST or other standards. In an embodiment, the one or more custom policies can be a stricter version that the company wants to enforce. The detailed description related to the one or more custom policies is explained in FIG. 8.

Continuously updating the compliance status refers to the ongoing process of monitoring and refreshing the compliance state to reflect real-time changes in the cloud and application infrastructures. The one or more dynamic shifts are changes that occur within the infrastructure over time, such as new resource deployments, configuration modifications, permission updates, or key status changes. For example, when a new virtual machine is deployed in a GCP environment, the system continuously monitors its encryption key status; if the key (Seventh-Key) becomes inactive while still encrypting the virtual machine (vm-03), the security analyzing subsystem 416 immediately updates the compliance status to reflect this deviation from NIST SP 800-53 requirements and alerts the security team to take corrective action.

The security analyzing subsystem 416 is further configured to identify one or more potential risks in at least one of: the one or more cloud infrastructures and the one or more application infrastructures. Identifying the potential risks refers to the process of detecting and recognizing security threats, vulnerabilities, and weaknesses that could compromise the integrity, availability, or confidentiality of an organization's technology environment. The one or more potential risks are possible security threats or vulnerabilities that have not yet resulted in incidents but could be exploited if left unaddressed, such as misconfigurations, excessive permissions, exposed credentials, or outdated encryption keys. The one or more cloud infrastructures comprise the hardware and software components, such as servers, storage, virtual machines, and networking resources, that enable cloud computing services provided by platforms like AWS, GCP, and Azure. The one or more application infrastructures comprise the underlying frameworks and components that support the deployment, operation, and management of software applications, including containers, databases, APIs, and service accounts. The security analyzing subsystem 416 identifies potential risks by analyzing the relationships and dependencies within the dynamic knowledge graphs, detecting patterns that indicate vulnerabilities such as privilege escalation paths, unrotated secrets, or inactive encryption keys still securing critical resources.

For example, by analyzing the dynamic knowledge graph, the security analyzing subsystem 416 may identify that an inactive encryption key (Seventh-Key) is still being used to encrypt a virtual machine (vm-03) and a datastore (New-Datastore-4), flagging this as a potential risk because inactive keys are more susceptible to compromise and violate security best practices, thereby alerting the security team to rotate the key before an incident occurs.

The plurality of subsystems 310 further includes the model learning subsystem 418 that is communicatively connected to the one or more hardware processors 306. The model learning subsystem 418 is configured to automatically learn from one or more remediation actions and telemetry data to continuously refine the one or more adaptive security posture recommendations for improving accuracy of the LLM over time. For automatically learning from the one or more remediation actions and telemetry data, the model learning subsystem 418 is initially configured to collecting the one or more remediation actions taken by the one or more users in response to the one or more adaptive security posture recommendations. The one or more remediation actions comprise at least one of: one or more steps taken to address detected security issues, compliance gaps, and misconfigurations within at least one of: the one or more cloud infrastructures and the one or more application infrastructures.

The model learning subsystem 418 is a component of the system that enables the AI-based system 302 to automatically learn from past actions and operational data to continuously improve the accuracy and relevance of the adaptive security posture recommendations over time. Automatically learning refers to the process by which the model learning subsystem 418 captures, analyzes, and incorporates insights from user actions and infrastructure data without requiring manual intervention, enabling the LLM to become more accurate and context-aware with each iteration. The one or more remediation actions are the corrective steps taken by the one or more users in response to the one or more adaptive security posture recommendations to address and resolve detected security issues, compliance gaps, and misconfigurations within the cloud and application infrastructures.

The detected security issues are identified vulnerabilities, threats, or weaknesses such as unrotated secrets, privilege escalation paths, or inactive encryption keys that require corrective action. The compliance gaps are deviations from industry standards such as NIST, GDPR, or HIPAA that need to be addressed to meet regulatory requirements. In other words, the compliance gaps are custom requirements for a given company. The misconfigurations are incorrect or suboptimal settings within infrastructure components that could expose the organization to security risks, such as overly permissive access controls or improperly configured encryption. The telemetry data comprises real-time operational metrics, security events, configuration changes, and performance indicators collected from the cloud and application infrastructures that provide insights into the current state and behavior of the system. For example, when the recommendation generating subsystem 412 recommends rotating an inactive encryption key (Seventh-Key) and the user successfully rotates the key and re-encrypts the virtual machine (vm-03), the model learning subsystem 418 collects this remediation action along with telemetry data showing improved compliance status, learns that this recommendation was effective, and refines future recommendations to prioritize similar key rotation actions for inactive keys securing critical resources.

For automatically learning from the one or more remediation actions and telemetry data, the model learning subsystem 418 is further configured to continuously collect the telemetry data from at least one of: the one or more cloud infrastructures and the one or more application infrastructures. The telemetry data may include at least one of: real-time operational metrics, security events, configuration changes, and performance indicators associated with the one or more infrastructure components. The Telemetry data is operational information automatically collected from the cloud and application infrastructures that provides real-time visibility into the state and behavior of infrastructure components. The real-time operational metrics are live measurements of system performance such as CPU usage, memory consumption, network latency, and resource utilization. The security events are logged occurrences related to security activities such as login attempts, access requests, permission changes, firewall alerts, and detected threats. The configuration changes are modifications made to infrastructure settings such as updated access permissions, new resource deployments, altered encryption settings, or changed network rules. The performance indicators are measurable values that reflect the health and efficiency of infrastructure components such as response times, error rates, uptime percentages, and throughput levels. For example, when a user rotates an inactive encryption key (Seventh-Key) to secure a virtual machine (vm-03), the model learning subsystem 418 continuously collects telemetry data including the configuration change event (key rotation), security events (new key activation), and performance indicators (encryption operation success rate), enabling the model learning subsystem 418 to correlate these data points with the remediation action and determine its effectiveness.

For automatically learning from the one or more remediation actions and telemetry data, the model learning subsystem 418 is further configured to analyze effectiveness of the one or more remediation actions by correlating the one or more remediation actions with subsequent changes in the telemetry data. The analysis determines whether the one or more remediation actions successfully resolved the detected security issues and improved the overall one or more security posture recommendations. Analyzing effectiveness refers to the process of evaluating whether the remediation actions taken by the one or more users successfully addressed the detected security issues and improved the overall security posture. Correlating is the process of establishing relationships between the remediation actions and subsequent changes observed in the telemetry data to determine cause-and-effect outcomes. The subsequent changes are the modifications or updates in the telemetry data that occur after a remediation action is performed, such as updated key statuses, resolved alerts, or improved compliance scores. Successfully resolved means that the detected security issues have been fully addressed and no longer pose a risk to the infrastructure. The improved overall security posture indicates that the organization's security state has been enhanced as a result of the remediation actions, reflected by fewer vulnerabilities, better compliance, and reduced risk exposure. For example, after a user rotates an inactive encryption key (Seventh-Key) as recommended, the model learning subsystem 418 correlates this remediation action with subsequent telemetry data showing the key status changed to active, the compliance alert for NIST SP 800-53 violation was cleared, and the virtual machine (vm-03) is now secured with a properly rotated key, thereby determining that the remediation action was effective and the security posture has improved. For automatically learning from the one or more remediation actions and telemetry data, the model learning subsystem 418 is further configured to identify one or more patterns and correlations between one or more specific remediation actions and outcomes of the one or more specific remediation actions. The one or more patterns indicate which remediation strategies are optimized effective for specific types of security vulnerabilities, compliance gaps, and infrastructure configurations. Identifying patterns and correlations refers to the process of recognizing recurring relationships between specific remediation actions and their outcomes to determine which strategies work best for particular security issues. The one or more patterns are recurring trends or sequences observed across multiple remediation actions that reveal consistent outcomes, such as certain key rotation procedures consistently resolving compliance gaps. The one or more correlations are statistical or logical relationships that link specific remediation actions to their resulting outcomes, indicating cause-and-effect connections. The remediation strategies are the specific approaches or methods used to address security issues, such as rotating keys, updating permissions, or patching vulnerabilities. The optimized effective means the most efficient and successful approach that achieves the desired security outcome with minimal effort or risk. The security vulnerabilities are weaknesses that could be exploited, compliance gaps are deviations from industry standards, and infrastructure configurations are the specific settings and arrangements of cloud and application components. For example, after analyzing multiple instances where inactive encryption keys were rotated, the model learning subsystem 418 identifies a pattern showing that immediate key rotation followed by re-encryption of affected resources (such as rotating Seventh-Key and re-encrypting vm-03) consistently resolves NIST SP 800-53 compliance gaps within 24 hours, indicating this remediation strategy is optimized effective for addressing inactive key vulnerabilities in GCP environments.

In an embodiment, the automatic learning may be performed in three ways. The first one is fine tuning which takes customer/user action (such as liked or disliked response, implicit signals such as asking similar questions to get answers) and fine tune the LLM to optimize the result for future queries. The second one is retrieval-augmented generation describing that the log good response and bad responses for a given category and store in vector database. When the customer/user enters prompt, the system analyzes closest example of good response and bad response and append to LLM query as examples. This will instruct the LLM to follow good answers and avoid bad ones. The third one is pattern describing that the system learn from patterns and recurring trends and add patches to produce good or bad answers.

For automatically learning from the one or more remediation actions and telemetry data, the model learning subsystem 418 is further configured to update the LLM using the identified one or more patterns and correlations. The LLM is updated to incorporate one or more learned insights, adapting the generation of accurate and context-aware one or more adaptive security posture recommendations. Updating the LLM refers to the process of refining and improving the large language model by incorporating new knowledge gained from analyzing remediation actions and their outcomes. The identified one or more patterns and correlations are the recognized relationships between specific remediation actions and their effectiveness that have been discovered through analysis of telemetry data and user actions. The one or more learned insights are the knowledge and understanding derived from analyzing which remediation strategies successfully resolved specific types of security issues, compliance gaps, and infrastructure configurations. Incorporating means integrating these learned insights into the LLM's knowledge base so that future recommendations benefit from past experiences. Adapting the generation refers to modifying how the LLM produces recommendations to reflect the newly incorporated knowledge, ensuring outputs are more relevant and effective. The accurate recommendations are suggestions that correctly identify and address the actual security issues present in the infrastructure. The context-aware recommendations are suggestions tailored to the specific environment, configurations, and circumstances of the organization's cloud and application infrastructures. For example, after the model learning subsystem 418 learns that rotating inactive encryption keys within 24 hours consistently resolves NIST SP 800-53 compliance gaps, the LLM is updated to incorporate this insight, so when it detects a similar situation with an inactive key (bucket-key) encrypting datastores (cielara-bucket), the model learning subsystem 418 generates a context-aware recommendation prioritizing immediate key rotation with a specific 24-hour timeframe based on proven effectiveness.

For automatically learning from the one or more remediation actions and telemetry data, the model learning subsystem 418 is further configured to continuously refining the one or more adaptive security posture recommendations based on the accumulated learning of the LLM. The refined one or more adaptive security posture recommendations possess improved accuracy, relevance, and effectiveness in addressing security risks and determining compliance with the one or more industry standards. Continuously refining refers to the ongoing process of improving and enhancing the adaptive security posture recommendations over time as the LLM accumulates more knowledge from remediation actions and telemetry data. The accumulated learning is the collective knowledge and insights the LLM has gathered from analyzing past remediation actions, their outcomes, and patterns of effectiveness across various security scenarios. The refined one or more recommendations are improved suggestions that have been enhanced based on accumulated learning, making them more precise and actionable than earlier recommendations. The improved accuracy means the recommendations more correctly identify the actual security issues and appropriate remediation steps. The improved relevance means the recommendations are better tailored to the specific context and needs of the organization's infrastructure. The improved effectiveness means the recommendations are more likely to successfully resolve security risks and achieve compliance when implemented. For example, initially the model learning subsystem 418 may recommend generic key rotation for inactive encryption keys, but after accumulating learning from multiple successful remediations, the refined recommendation becomes more specific: "Rotate inactive key Seventh-Key immediately, re-encrypt vm-03 and New-Datastore-4 using a new active key, and schedule automated key rotation every 90 days to maintain NIST SP 800-53 compliance"—demonstrating improved accuracy, relevance, and effectiveness based on proven remediation patterns.

For automatically learning from the one or more remediation actions and telemetry data, the model learning subsystem 418 is further configured to identify refining by reinforcement learning that optimizes a result by taking user feedback and codifying at least one of: self-learning and reinforcement learning into knowledge, for analyzing the effectiveness of the one or more remediation actions. Refining by reinforcement learning refers to the process of improving the system's recommendations through a feedback-driven learning approach where the model learning subsystem 418 learns from the outcomes of its actions and user responses to optimize future results. The reinforcement learning is a type of machine learning where the model learning subsystem 418 learns to make better decisions by receiving feedback on its actions, rewarding successful outcomes and adjusting behavior to avoid unsuccessful ones. Optimizing the result means improving the quality and effectiveness of the adaptive security posture recommendations by continuously adjusting the system's approach based on what works best. The user feedback is the input provided by the one or more users indicating whether the recommendations were helpful, accurate, and effective in resolving security issues, which can include explicit ratings, acceptance or rejection of recommendations, or observed user actions.

Codifying refers to the process of converting learned experiences and feedback into structured knowledge that the system can store and apply to future recommendations. Self-learning is the system's ability to autonomously improve its performance by analyzing its own outputs and outcomes without requiring explicit human instruction. Knowledge represents the accumulated understanding and insights that the system stores and uses to generate more accurate and effective recommendations over time. Analyzing effectiveness refers to evaluating how well the remediation actions resolved the detected security issues based on the reinforcement learning feedback loop. For example, when the model learning subsystem 418 recommends rotating an inactive encryption key (Seventh-Key) and the user implements this action, the model learning subsystem 418 receives positive feedback through telemetry data showing the compliance gap was resolved; this feedback is codified into knowledge through reinforcement learning, teaching the model learning subsystem 418 that immediate key rotation is effective for inactive key vulnerabilities. Conversely, if a user rejects a recommendation or the remediation fails, the model learning subsystem 418 learns from this negative feedback and refines its approach, optimizing future recommendations to suggest alternative strategies such as creating a new key before decommissioning the old one to avoid service disruptions.

As shown in FIG. 5, the flow diagram representation 500 starts with a user prompt, where the one or more users asks the one or more queries (security-related queries). The user prompt is analyzed by the one or more LLMs, which interprets the intent of the one or more users and generates one of: a graph query of the one or more graph queries and a semantic search request. The AI-based system 302 formulates the graph query to extract specific data and relationships from the one or more dynamic knowledge graphs 502. The one or more dynamic knowledge graphs 502 map the one or more infrastructure components (e.g., virtual machines, service accounts, data stores) and the relationships, such as one of: a virtual machine authenticating as a service account and a service account accessing a datastore. This relationship data provides deep context for the security analysis.

Simultaneously, the AI-based system 302 optionally performs a semantic search (as explained in para.) in the vector database to identify the one or more relevant elements similar to those described in the graph query. The vector embeddings are used to convert the natural language descriptions into semantic representations, enabling the AI-based system 302 to find the one or more relevant elements efficiently (e.g., other virtual machines with similar authentication issues). For instance, the natural language descriptions may be “Virtual Machine vm-01 authenticates as service account svc-a, which allows access to datastore ds-02”. The results from the graph query and the semantic search are combined. The one or more LLMs synthesize the results and generate the one or more adaptive security posture recommendations.

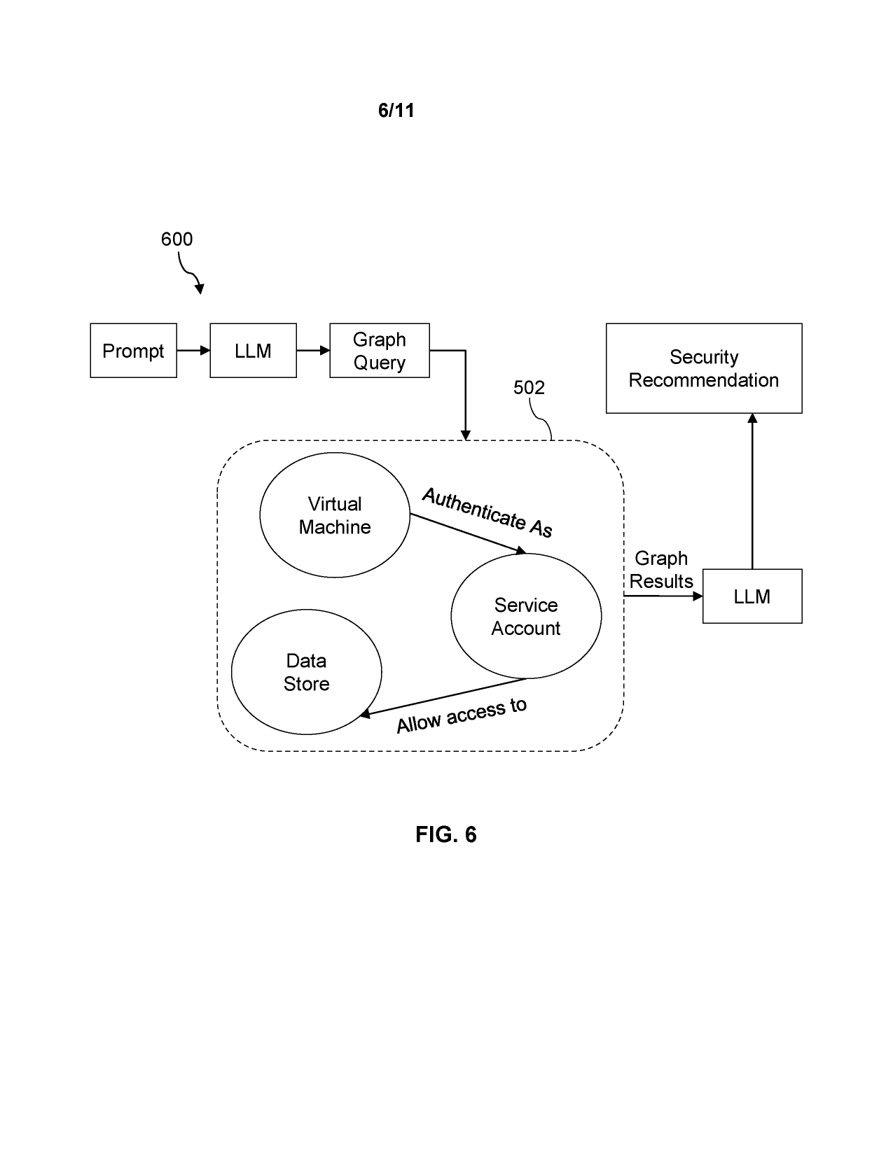

FIG. 6 illustrates an exemplary flow diagram representation 600 depicting the generation of the one or more adaptive security posture recommendations without semantic search method and the one or more custom policies, in accordance with an embodiment of the present disclosure. In this representation 600, the semantic search is an optional method since having both graph queries and semantic search are not required. Further, in this context, the graph queries method is essential for LLM to understand the context and provide useful analysis, and the semantic search method can be used optionally

FIG. 7 illustrates an exemplary visual representation 700 depicting the user interface associated with the one or more electronic devices 314, in accordance with an embodiment of the present disclosure.

In an exemplary embodiment, a query 702 of the one or more queries may be "Are credentials meeting an NIST 800-53 compliance requirement?". The query sets the context for the analysis. The AI-based system 302 processes the query by leveraging the one or more dynamic knowledge graphs 502 to analyze the credentials and the usage. The analysis checks for compliance deviations based on key elements such as the status of encryption keys (active or inactive) and the roles in securing resources. The user interface displays the analysis results 704 under resource analysis and recommendations, specifically focusing on credential management and key usage. These findings are directly derived by traversing through the one or more dynamic knowledge graphs 502 and identifying the status and usage of the credentials across various resources. The AI-based system 302 compares the credential findings against the NIST 800-53 standards, thereby identifying non-compliance issues such as the presence of inactive encryption keys still being used to secure critical resources. The purpose is to ensure that all credentials (e.g., encryption keys) are active, secure, and compliant with the one or more industry standards for managing sensitive data and preventing unauthorized access. Based on the analysis, the AI-based system 302 provides the one or more adaptive security posture recommendations to address the non-compliance issues.

FIG. 8 illustrates an exemplary visual representation 800 depicting a user interface associated with the one or more custom policies 802, in accordance with an embodiment of the present disclosure. The one or more custom policies 802 are user-defined compliance rules expressed in natural language that instructs an AI-based system 302 how to evaluate cloud infrastructure. Unlike traditional rule-based compliance systems that require programming in domain-specific languages, features of the one or more custom policies 802 allow technical and non-technical administrators to write analysis instructions in plain language such as English. These instructions are dynamically injected into Large Language Model prompts at runtime, enabling the AI-based system 302 to evaluate infrastructure against organization-specific requirements without code changes or redeployment.

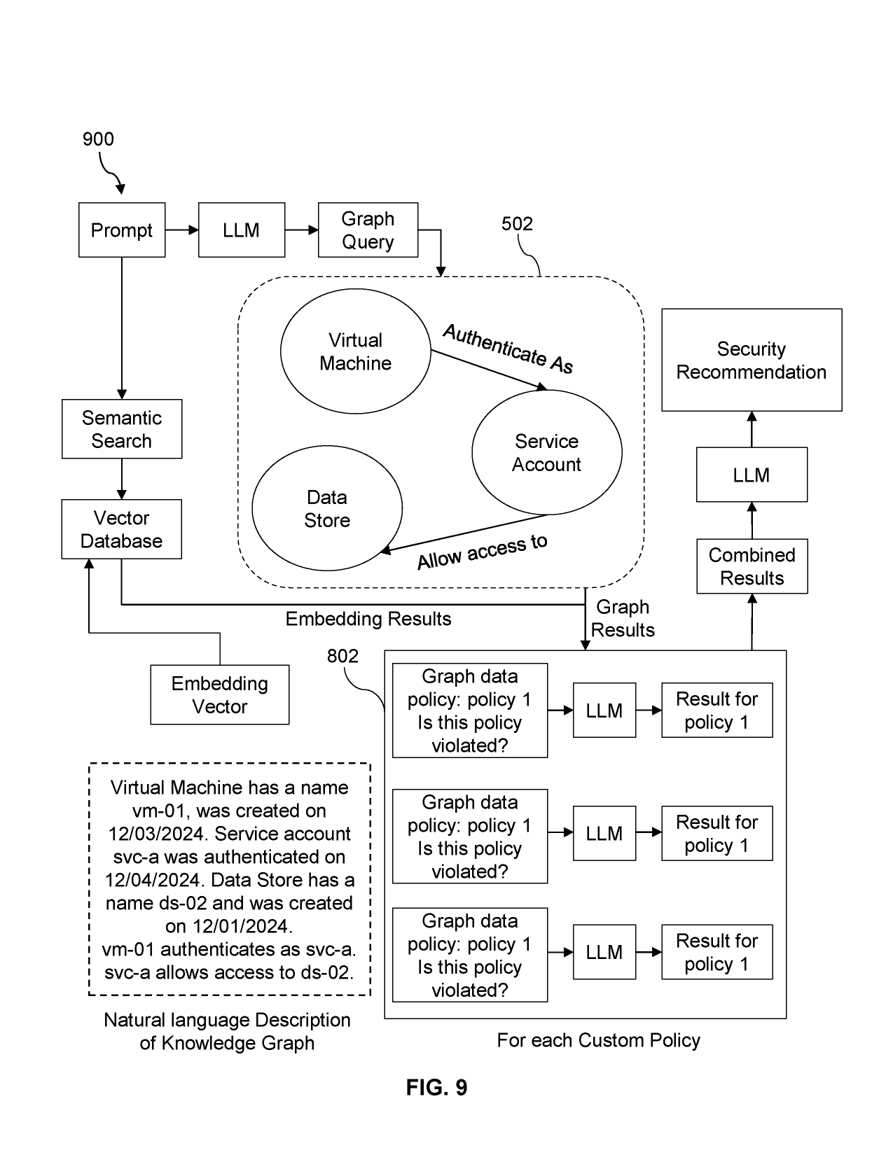

FIG. 9 illustrates an exemplary flow diagram representation 900 depicting a custom policy architecture with the generation of the one or more adaptive security recommendations using the one or more dynamic knowledge graphs 502 with the one or more custom policies 802, in accordance with an embodiment of the present disclosure. The one or more dynamic knowledge graphs 502 with the graph results generate combined results using the one or more custom policies 802. The custom policy architecture enables organization-specific compliance and security evaluation using LLMs. A user prompt is first interpreted by an LLM, which translates the request into structured graph queries. These queries are executed against an Adaptive Knowledge Graph that models cloud entities (e.g., virtual machines, service accounts, data stores) and their relationships (e.g., authenticates as, allows access to). In parallel, natural-language descriptions of the knowledge graph are embedded and stored in a vector database. The semantic search method is used to retrieve relevant contextual information that may not be captured by strict graph queries alone, improving coverage and recall.

The AI-based system 302 combines precise knowledge graph queries with semantic search over embedded infrastructure descriptions to gather relevant context. Each custom policy is evaluated independently by an LLM against this evidence, and the results are then aggregated to produce clear, explainable security or compliance recommendations.

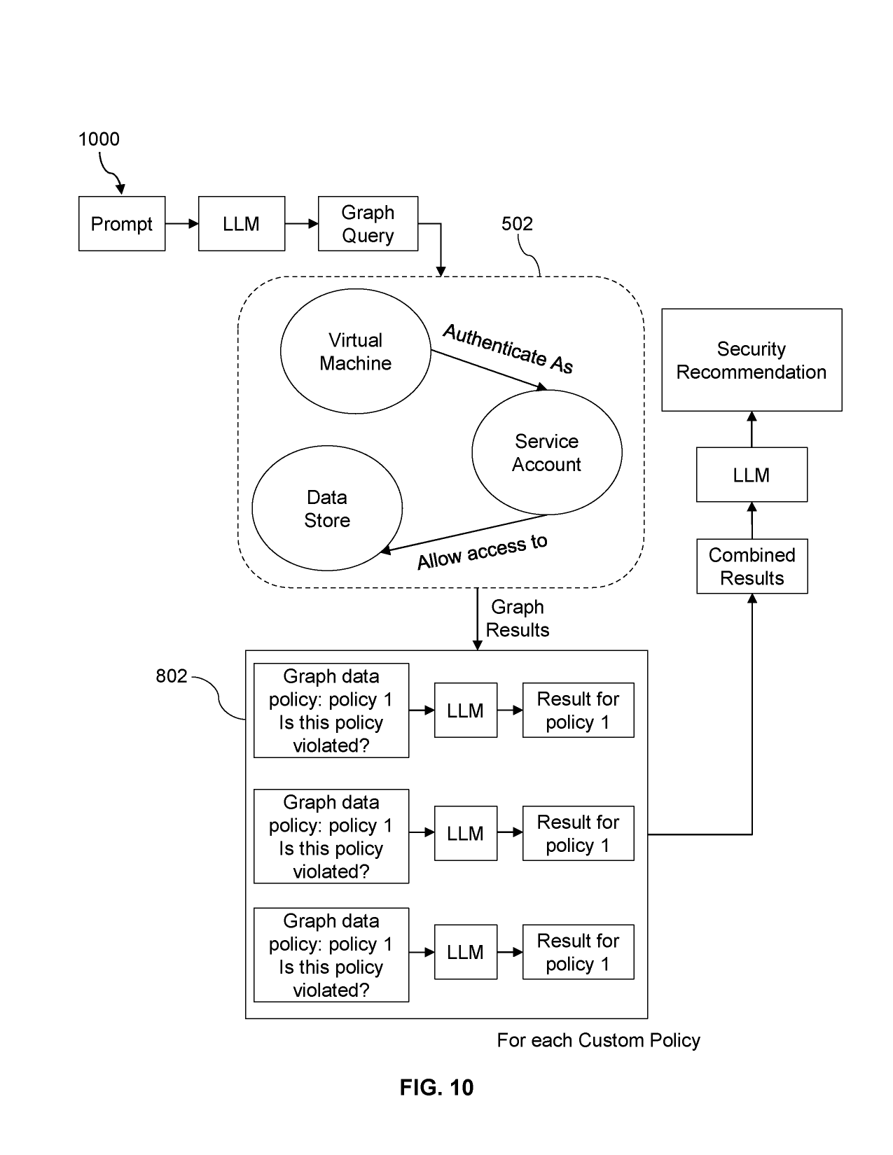

FIG. 10 illustrates an exemplary flow diagram representation 1000 depicting the custom policy architecture with the generation of the one or more adaptive security recommendations with the one or more custom policies 802 and without the semantic search method, in accordance with an embodiment of the present disclosure. The semantic search method is optionally used in providing the context to the LLM as the graph query method is essentially performed for the LLM to understand the context and provide useful analysis.

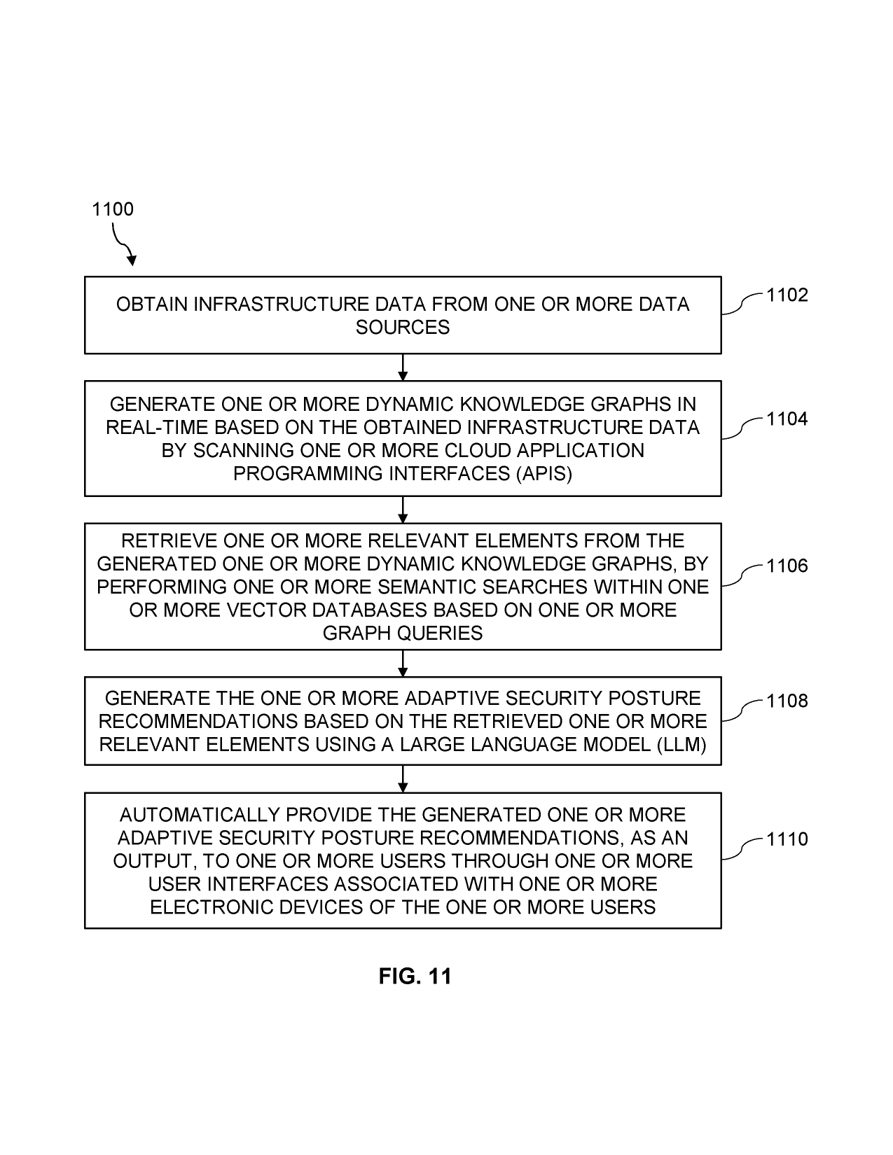

FIG. 11 is a flow chart illustrating an AI-based method 1100 for automatically providing the one or more adaptive security posture recommendations using the one or more dynamic knowledge graphs, in accordance with an embodiment of the present disclosure.

At step 1102, the infrastructure data are obtained from the one or more data sources (e.g., the one or more databases 316). The one or more data sources may include at least one of: the one or more cloud providers and the one or more development and operations services. The infrastructure data may include data associated with at least one of: the one or more cloud infrastructures and the one or more application infrastructures.

At step 1104, the one or more dynamic knowledge graphs are generated in real-time based on the obtained infrastructure data by scanning the one or more cloud application programming interfaces (APIs). In an embodiment, the one or more dynamic knowledge graphs indicate the one or more relationships and dependencies of the one or more infrastructure components. In another embodiment, the one or more dynamic knowledge graphs may include the one or more nodes indicating each infrastructure component of the one or more infrastructure components and the one or more edges indicating the one or more relationships and dependencies of the one or more infrastructure components.

At step 1106, the one or more relevant elements are retrieved from the generated one or more dynamic knowledge graphs, by performing the one or more semantic searches within the one or more vector databases based on the one or more graph queries.

At step 1108, the one or more adaptive security posture recommendations are generated based on the retrieved one or more relevant elements using the LLM.

At step 1110, the generated one or more adaptive security posture recommendations are automatically provided as the output to the one or more users through the one or more user interfaces associated with the one or more electronic devices 314 of the one or more users.

Numerous advantages of the present disclosure may be apparent from the discussion above. in accordance with the present disclosure, the AI-based system 302 for automatically providing the one or more adaptive security posture recommendations using the one or more dynamic knowledge graphs is disclosed. The AI-based system 302 enables the identification of complex dependencies and potential vulnerabilities within at least one of: the one or more cloud infrastructures and the one or more application infrastructures, assisting the organizations in better understanding the security posture. The AI-based system 302 is configured with a semantic search capability that provides tailored and context-aware one or more adaptive security posture recommendations, thereby making the system highly user-friendly and efficient.

The AI-based system 302 significantly reduces search complexity, enabling faster and more accurate retrieval of the one or more relevant elements from the one or more dynamic knowledge graphs. The AI-based system 302 reduces the manual effort traditionally required for auditing and compliance management, streamlines incident response with detailed root cause analysis, and provides corrective action guidance that accelerates remediation, thereby ultimately enhancing the overall security and compliance posture of the organizations.

The AI-based system 302 provides the one or more adaptive security posture recommendations, empowering the organizations to address complex security challenges and optimize the performance of at least one of: the cloud infrastructures and the application infrastructures, and resilience. The AI-based system 302 enables advanced dependency visualization, root cause analysis, and operational optimization across hybrid and multi-cloud environments. The AI-based system 302 assists the organizations in proactively identifying security risks, maintaining compliance, and implementing remediation strategies tailored to the hybrid and multi-cloud environments. The AI-based system 302 provides a faster and more accurate way to analyze and generate compliance reports using the one or more adaptive knowledge graphs and the one or more LLMs. The AI-based system 302 detects risks such as unrotated secrets, privilege escalation paths, and misconfigurations before the risks become incidents. The AI-based system 302 reduces attack surface and enhances compliance through continuous monitoring and validation. The AI-based system 302 provides specific remediation guidance aligned with the one or more industry standards. The AI-based system 302 provides prioritized, actionable steps based on the context of the hybrid and multi-cloud environments and current risk profiles.

The AI-based system 302 dynamically enforces policies and updates compliance status as at least one of: the one or more cloud infrastructures and the one or more application infrastructures evolve. The AI-based system 302 highlights areas of non-compliance and provides corrective steps in real time. The AI-based system 302 is configured to scale with increasing infrastructure complexity, thereby supporting large organizations with the hybrid and multi-cloud environments. The AI-based system 302 is extensible to accommodate new compliance rules, cloud services, and security best practices.

The AI-based system 302 rapidly traces security incidents to a root cause by analyzing dependencies in the one or more dynamic knowledge graphs. The AI-based system 302 accelerates incident response with context-rich insights, reducing downtime and recovery costs. The AI-based system 302 learns from remediation actions and telemetry data to continuously refine recommendations and improve accuracy over time. The AI-based system 302 serves as a shared source of truth for DevOps, security, and governance teams, fostering collaboration and reducing communication barriers. The AI-based system 302 supports at least one of: multi cloud, on-premises, Kubernetes^{®}, and the Hashicorp Vault^{®}, making a truly unified experience. The AI-based system 302 provides context-aware insights (e.g., “Service X has unrotated secrets older than six months, violating NIST guidelines. Rotate the keys immediately.”). The AI-based system 302 is configured to simulate the security risks and the compliance gaps based on dynamic infrastructure changes.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based system 302 either directly or through intervening I/O controllers. Network adapters may also be coupled to the AI-based system 302 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based system 302 in accordance with the embodiments herein. The AI-based system 302 herein comprises at least one processor or central processing unit (CPU). The CPUs are interconnected via the system bus 402 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based system 302. The AI-based system 302 can read the inventive instructions on the program storage devices and follow these instructions to execute the methodology of the embodiments herein.

The AI-based system 302 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words "comprising", "having", "containing", and "including", and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence (AI) based method for automatically providing one or more adaptive security posture recommendations using one or more dynamic knowledge graphs, the AI-based method comprising:
obtaining, by one or more hardware processors, infrastructure data from one or more data sources, wherein the one or more data sources comprise at least one of: one or more cloud providers and one or more development and operations services, and wherein the infrastructure data comprise data associated with at least one of: one or more cloud infrastructures and one or more application infrastructures;
generating, by the one or more hardware processors, the one or more dynamic knowledge graphs in real-time based on the obtained infrastructure data by scanning one or more cloud application programming interfaces (APIs), wherein the one or more dynamic knowledge graphs indicate one or more relationships and dependencies of one or more infrastructure components, and
wherein the one or more dynamic knowledge graphs comprise one or more nodes indicating each infrastructure component of the one or more infrastructure components and one or more edges indicating the one or more relationships and dependencies of the one or more infrastructure components;
retrieving, by the one or more hardware processors, one or more relevant elements from the generated one or more dynamic knowledge graphs, by performing one or more semantic searches within one or more vector databases based on one or more graph queries;
generating, by the one or more hardware processors, the one or more adaptive security posture recommendations based on the retrieved one or more relevant elements using a large language model (LLM); and
automatically providing, by the one or more hardware processors, the generated one or more adaptive security posture recommendations, as an output, to one or more users through one or more user interfaces associated with one or more electronic devices of the one or more users.

2. The AI-based method of claim 1, further comprising performing, by the one or more hardware processors, one or more operations comprising at least one of:
conducting, by the one or more hardware processors, one or more comprehensive security assessments, by:
detecting, by the one or more hardware processors, one or more security vulnerabilities comprising one or more unrotated secrets and privilege escalation paths, identifying gaps in compliance, wherein the one or more unrotated secrets refer to one or more security credentials that have not been updated within a pre-determined time period as required by one or more security policies and one or more industry standards;
providing, by the one or more hardware processors, clear and actionable step-by-step instructions for addressing one or more detected security issues; and
providing, by the one or more hardware processors, one or more real-time security assessments, delivering proactive one or more adaptive security posture recommendations to mitigate one or more risks, and simulating one or more security scenarios to assess potential impact of infrastructure changes;
determining, by the one or more hardware processors, whether the one or more infrastructure components are in compliance with the one or more industry standards, by:
assessing, by the one or more hardware processors, whether the one or more infrastructure components conform to one or more requirements of the one or more industry standards, and identifying one or more deviations from the regulatory requirements, wherein the one or more industry standards comprise at least one of: National Institute of Standards and Technology (NIST), General Data Protection Regulation (GDPR), and Health Insurance Portability and Accountability Act (HIPAA); and
continuously updating, by the one or more hardware processors, compliance status to reflect one or more dynamic shifts in at least one of: the one or more cloud infrastructures and the one or more application infrastructures; and
identifying, by the one or more hardware processor, one or more potential risks in at least one of: the one or more cloud infrastructures and the one or more application infrastructures.

3. The AI-based method of claim 1, wherein retrieving the one or more relevant elements from the generated one or more dynamic knowledge graphs, comprises:
traversing, by the one or more hardware processors, one or more unprocessed nodes of the one or more dynamic knowledge graphs through one or more neighboring nodes;
generating, by the one or more hardware processors, a natural language description for each node and each edge of the one or more dynamic knowledge graphs during traversing of the one or more unprocessed nodes, using the LLM, wherein the natural language description incorporates a human-readable description of the one or more nodes and the one or more edges for a structure of the one or more adaptive knowledge graphs;
splitting, by the one or more hardware processors, the natural language description of the one or more dynamic knowledge graphs into one or more chunks;
generating, by the one or more hardware processors, one or more embedding vectors for each chunk of the one or more chunks, wherein the one or more embedding vectors encode semantic meaning of the natural language description;
storing, by the one or more hardware processors, the one or more embedding vectors in one or more vector databases; and
performing, by the one or more hardware processors, the one or more semantic searches with the one or more vector databases to retrieve the one or more relevant elements from the generated one or more dynamic knowledge graphs.

4. The AI-based method of claim 1, wherein generating the one or more adaptive security posture recommendations based on the retrieved one or more relevant elements using the LLM, comprises:
receiving, by the one or more hardware processors, one or more queries from the one or more electronic devices associated with the one or more users, wherein the one or more users provide the one or more queries in natural language, making an AI-based system accessible to the one or more users;
converting, by the one or more hardware processors, the one or more queries into the one or more graph queries, wherein the one or more graph queries comprise one or more cypher queries possessing one or more specific instructions on what infrastructure data to be retrieved;
extracting, by the one or more hardware processors, one or more relevant relationships and entities from the one or more dynamic knowledge graphs based on the one or more graph queries;
processing, by the one or more hardware processors, the one or more graph queries to extract the one or more relevant elements;
synthesizing, by the one or more hardware processors, the one or more adaptive security posture recommendations based on real-time infrastructure data and one or more insights using the LLM; and
generating, by the one or more hardware processors, the one or more adaptive security posture recommendations that are broken into one or more simple insights for adapting the one or more adaptive security posture recommendations to be understandable for the one or more users.

5. The AI-based method of claim 1, further comprising automatically learning, by the one or more hardware processors, from one or more remediation actions and telemetry data to continuously refine the one or more adaptive security posture recommendations for improving accuracy of the LLM over time, by:
collecting, by the one or more hardware processors, the one or more remediation actions taken by the one or more users in response to the one or more adaptive security posture recommendations; wherein the one or more remediation actions comprise at least one of: one or more steps taken to address detected security issues, compliance gaps, and misconfigurations within at least one of: the one or more cloud infrastructures and the one or more application infrastructures;
continuously collecting, by the one or more hardware processors, the telemetry data from at least one of: the one or more cloud infrastructures and the one or more application infrastructures, wherein the telemetry data comprises at least one of: real-time operational metrics, security events, configuration changes, and performance indicators associated with the one or more infrastructure components;
analyzing, by the one or more hardware processors, effectiveness of the one or more remediation actions by correlating the one or more remediation actions with subsequent changes in the telemetry data, wherein the analysis determines whether the one or more remediation actions successfully resolved the detected security issues and improved the overall one or more security posture recommendations;
identifying, by the one or more hardware processors, one or more patterns and correlations between one or more specific remediation actions and outcomes of the one or more specific remediation actions, wherein the one or more patterns indicate which remediation strategies are optimized effective for specific types of security vulnerabilities, compliance gaps, and infrastructure configurations;
updating, by the one or more hardware processors, the LLM using the identified one or more patterns and correlations, wherein the LLM is updated to incorporate one or more learned insights, adapting the generation of accurate and context-aware one or more adaptive security posture recommendations;
continuously refining, by the one or more hardware processors, the one or more adaptive security posture recommendations based on the accumulated learning of the LLM, wherein the refined one or more adaptive security posture recommendations possess improved accuracy, relevance, and effectiveness in addressing security risks and determining compliance with the one or more industry standards; and
identifying, by the one or more hardware processors, refining by reinforcement learning that optimizes a result by taking user feedback and codifying at least one of: self-learning and reinforcement learning into knowledge, for analyzing the effectiveness of the one or more remediation actions.

6. The AI-based method of claim 1, further comprising simulating and predicting, by the one or more hardware processors, the security risks and potential compliance gaps based on dynamic infrastructure changes, by:
creating, by the one or more hardware processors, one or more virtual representations of proposed modifications to the one or more infrastructure components, comprising adding one or more new cloud services, changing configurations, modifying access permissions, and updating the dependencies;
analyzing, by the one or more hardware processors, the one or more dynamic knowledge graphs to determine how the proposed modifications affect the one or more relationships and dependencies between the one or more infrastructure components, identifying one or more potential new vulnerabilities;
assessing, by the one or more hardware processors, multi-hop impact by determining whether the proposed modifications to the one or more infrastructure components result in deviations from the one or more industry standards comprising internal standards and baseline, for identifying the potential compliance gaps before an occurrence of the proposed modifications; and
remediating, by the one or more hardware processors, with proactive one or more dynamic security posture recommendations to mitigate identified security risks, adapting the one or more organizations, based on simulation assessments, to make informed decisions about infrastructure changes and implement preventive measures.

7. The AI-based method of claim 1, further comprising:
tracing, by the one or more hardware processors, one or more security incidents to a root cause by analyzing the one or more relationships and dependencies in the one or more dynamic knowledge graphs; and
accelerating, by the one or more hardware processors, incident response with context-rich insights, for reducing downtime and associated recovery costs for one or more organizations.

8. An artificial intelligence (AI) based system for automatically providing one or more adaptive security posture recommendations using one or more dynamic knowledge graphs, the AI-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain infrastructure data from one or more data sources, wherein the one or more data sources comprise at least one of: one or more cloud providers and one or more development and operations services, and wherein the infrastructure data comprise data associated with at least one of: one or more cloud infrastructures and one or more application infrastructures;
a knowledge graph generating subsystem configured to generate the one or more dynamic knowledge graphs in real-time based on the obtained infrastructure data by scanning one or more cloud application programming interfaces (APIs), wherein the one or more dynamic knowledge graphs indicate one or more relationships and dependencies of one or more infrastructure components, and
wherein the one or more dynamic knowledge graphs comprise one or more nodes indicating each infrastructure component of the one or more infrastructure components and one or more edges indicating the one or more relationships and dependencies of the one or more infrastructure components;
an information retrieving subsystem configured to retrieve one or more relevant elements from the generated one or more dynamic knowledge graphs, by performing one or more semantic searches within one or more vector databases based on one or more graph queries;
a recommendation generating subsystem configured to generate the one or more adaptive security posture recommendations based on the retrieved one or more relevant elements using a large language model (LLM); and
an output subsystem configured to automatically provide the generated one or more adaptive security posture recommendations, as an output, to one or more users through one or more user interfaces associated with one or more electronic devices of the one or more users.

9. The AI-based system of claim 8, further comprising a security analyzing subsystem configured to:
conduct one or more comprehensive security assessments, by:
detecting one or more security vulnerabilities comprising one or more unrotated secrets and privilege escalation paths, identifying gaps in compliance, wherein the one or more unrotated secrets refer to one or more security credentials that have not been updated within a pre-determined time period as required by one or more security policies and one or more industry standards;
providing clear and actionable step-by-step instructions for addressing one or more detected security issues; and
providing one or more real-time security assessments, delivering proactive one or more adaptive security posture recommendations to mitigate one or more risks, and simulating one or more security scenarios to assess potential impact of infrastructure changes;
determine whether the one or more infrastructure components are in compliance with the one or more industry standards, by:
assessing whether the one or more infrastructure components conform to one or more requirements of the one or more industry standards, and identifying one or more deviations from the regulatory requirements, wherein the one or more industry standards comprise at least one of: National Institute of Standards and Technology (NIST), General Data Protection Regulation (GDPR), and Health Insurance Portability and Accountability Act (HIPAA); and
continuously updating compliance status to reflect one or more dynamic shifts in at least one of: the one or more cloud infrastructures and the one or more application infrastructures; and
identify one or more potential risks in at least one of: the one or more cloud infrastructures and the one or more application infrastructures.

10. The AI-based system of claim 8, wherein in retrieving the one or more relevant elements from the generated one or more dynamic knowledge graphs, the information retrieving subsystem is further configured to:
traverse one or more unprocessed nodes of the one or more dynamic knowledge graphs through one or more neighboring nodes;
generate a natural language description for each node and each edge of the one or more dynamic knowledge graphs during traversing of the one or more unprocessed nodes, using the LLM, wherein the natural language description incorporates a human-readable description of the one or more nodes and the one or more edges for a structure of the one or more adaptive knowledge graphs;
split the natural language description of the one or more dynamic knowledge graphs into one or more chunks;
generate one or more embedding vectors for each chunk of the one or more chunks, wherein the one or more embedding vectors encode semantic meaning of the natural language description;
store the one or more embedding vectors in one or more vector databases; and
perform the one or more semantic searches with the one or more vector databases to retrieve the one or more relevant elements from the generated one or more dynamic knowledge graphs.

11. The AI-based system of claim 8, wherein in generating the one or more adaptive security posture recommendations based on the retrieved one or more relevant elements using the LLM, the recommendation generating subsystem is further configured to:
receive one or more queries from the one or more electronic devices associated with the one or more users, wherein the one or more users provide the one or more queries in natural language, making an AI-based system accessible to the one or more users;
convert the one or more queries into the one or more graph queries, wherein the one or more graph queries comprise one or more cypher queries possessing one or more specific instructions on what infrastructure data to be retrieved;
extract one or more relevant relationships and entities from the one or more dynamic knowledge graphs based on the one or more graph queries;
process the one or more graph queries to extract the one or more relevant elements;
synthesize the one or more adaptive security posture recommendations based on real-time infrastructure data and one or more insights using the LLM; and
generate the one or more adaptive security posture recommendations that are broken into one or more simple insights for adapting the one or more adaptive security posture recommendations to be understandable for the one or more users.

12. The AI-based system of claim 8, further comprising a model learning subsystem configured to automatically learn from one or more remediation actions and telemetry data to continuously refine the one or more adaptive security posture recommendations for improving accuracy of the LLM over time, by:
collecting the one or more remediation actions taken by the one or more users in response to the one or more adaptive security posture recommendations; wherein the one or more remediation actions comprise at least one of: one or more steps taken to address detected security issues, compliance gaps, and misconfigurations within at least one of: the one or more cloud infrastructures and the one or more application infrastructures;
continuously collecting the telemetry data from at least one of: the one or more cloud infrastructures and the one or more application infrastructures, wherein the telemetry data comprises at least one of: real-time operational metrics, security events, configuration changes, and performance indicators associated with the one or more infrastructure components;
analyzing effectiveness of the one or more remediation actions by correlating the one or more remediation actions with subsequent changes in the telemetry data, wherein the analysis determines whether the one or more remediation actions successfully resolved the detected security issues and improved the overall one or more security posture recommendations;
identifying one or more patterns and correlations between one or more specific remediation actions and outcomes of the one or more specific remediation actions, wherein the one or more patterns indicate which remediation strategies are optimized effective for specific types of security vulnerabilities, compliance gaps, and infrastructure configurations;
updating the LLM using the identified one or more patterns and correlations, wherein the LLM is updated to incorporate one or more learned insights, adapting the generation of accurate and context-aware one or more adaptive security posture recommendations;
continuously refining the one or more adaptive security posture recommendations based on the accumulated learning of the LLM, wherein the refined one or more adaptive security posture recommendations possess improved accuracy, relevance, and effectiveness in addressing security risks and determining compliance with the one or more industry standards; and
identify refining by reinforcement learning that optimizes a result by taking user feedback and codifying at least one of: self-learning and reinforcement learning into knowledge, for analyzing the effectiveness of the one or more remediation actions.

13. The AI-based system of claim 8, wherein the recommendation generating subsystem is further configured to simulate and predict the security risks and potential compliance gaps based on dynamic infrastructure changes, by:
creating one or more virtual representations of proposed modifications to the one or more infrastructure components, comprising adding one or more new cloud services, changing configurations, modifying access permissions, and updating the dependencies;
analyzing the one or more dynamic knowledge graphs to determine how the proposed modifications affect the one or more relationships and dependencies between the one or more infrastructure components, identifying one or more potential new vulnerabilities;
assessing multi-hop impact by determining whether the proposed modifications to the one or more infrastructure components result in deviations from the one or more industry standards comprising internal standards and baseline, for identifying the potential compliance gaps before an occurrence of the proposed modifications; and
remediating with proactive one or more dynamic security posture recommendations to mitigate identified security risks, adapting the one or more organizations, based on simulation assessments, to make informed decisions about infrastructure changes and implement preventive measures.

14. The AI-based system of claim 8, wherein the recommendation generating subsystem is further configured to:
trace one or more security incidents to a root cause by analyzing the one or more relationships and dependencies in the one or more dynamic knowledge graphs; and
accelerate incident response with context-rich insights, for reducing downtime and associated recovery costs for one or more organizations.

15. A non-transitory computer-readable storage medium having instructions stored therein that when executed by one or more hardware processors, cause the one or more hardware processors to execute operations of:
obtaining infrastructure data from one or more data sources, wherein the one or more data sources comprise at least one of: one or more cloud providers and one or more development and operations services, and wherein the infrastructure data comprise data associated with at least one of: one or more cloud infrastructures and one or more application infrastructures;
generating one or more dynamic knowledge graphs in real-time based on the obtained infrastructure data by scanning one or more cloud application programming interfaces (APIs), wherein the one or more dynamic knowledge graphs indicate one or more relationships and dependencies of one or more infrastructure components, and
wherein the one or more dynamic knowledge graphs comprise one or more nodes indicating each infrastructure component of the one or more infrastructure components and one or more edges indicating the one or more relationships and dependencies of the one or more infrastructure components;
retrieving one or more relevant elements from the generated one or more dynamic knowledge graphs, by performing one or more semantic searches within one or more vector databases based on one or more graph queries;
generating one or more adaptive security posture recommendations based on the retrieved one or more relevant elements using a large language model (LLM); and
automatically providing the generated one or more adaptive security posture recommendations, as an output, to one or more users through one or more user interfaces associated with one or more electronic devices of the one or more users.

16. The non-transitory computer-readable storage medium of claim 15, further comprising performing one or more operations comprising at least one of:
conducting one or more comprehensive security assessments, by:
detecting one or more security vulnerabilities comprising one or more unrotated secrets and privilege escalation paths, identifying gaps in compliance, wherein the one or more unrotated secrets refer to one or more security credentials that have not been updated within a pre-determined time period as required by one or more security policies and one or more industry standards;
providing clear and actionable step-by-step instructions for addressing one or more detected security issues; and
providing one or more real-time security assessments, delivering proactive one or more adaptive security posture recommendations to mitigate one or more risks, and simulating one or more security scenarios to assess potential impact of infrastructure changes;
determining whether the one or more infrastructure components are in compliance with the one or more industry standards, by:
assessing whether the one or more infrastructure components conform to one or more requirements of the one or more industry standards, and identifying one or more deviations from the regulatory requirements, wherein the one or more industry standards comprise at least one of: National Institute of Standards and Technology (NIST), General Data Protection Regulation (GDPR), and Health Insurance Portability and Accountability Act (HIPAA); and
continuously updating compliance status to reflect one or more dynamic shifts in at least one of: the one or more cloud infrastructures and the one or more application infrastructures; and
identifying one or more potential risks in at least one of: the one or more cloud infrastructures and the one or more application infrastructures.

17. The non-transitory computer-readable storage medium of claim 15, wherein retrieving the one or more relevant elements from the generated one or more dynamic knowledge graphs, comprises:
traversing one or more unprocessed nodes of the one or more dynamic knowledge graphs through one or more neighboring nodes;
generating a natural language description for each node and each edge of the one or more dynamic knowledge graphs during traversing of the one or more unprocessed nodes, using the LLM, wherein the natural language description incorporates a human-readable description of the one or more nodes and the one or more edges for a structure of the one or more adaptive knowledge graphs;
splitting the natural language description of the one or more dynamic knowledge graphs into one or more chunks;
generating one or more embedding vectors for each chunk of the one or more chunks, wherein the one or more embedding vectors encode semantic meaning of the natural language description;
storing the one or more embedding vectors in one or more vector databases; and
performing the one or more semantic searches with the one or more vector databases to retrieve the one or more relevant elements from the generated one or more dynamic knowledge graphs.

18. The non-transitory computer-readable storage medium of claim 15, wherein generating the one or more adaptive security posture recommendations based on the retrieved one or more relevant elements using the LLM, comprises:
receiving one or more queries from the one or more electronic devices associated with the one or more users, wherein the one or more users provide the one or more queries in natural language, making the AI-based system accessible to the one or more users;
converting the one or more queries into the one or more graph queries, wherein the one or more graph queries comprise one or more cypher queries possessing one or more specific instructions on what infrastructure data to be retrieved;
extracting one or more relevant relationships and entities from the one or more dynamic knowledge graphs based on the one or more graph queries;
processing the one or more graph queries to extract the one or more relevant elements;
synthesizing the one or more adaptive security posture recommendations based on real-time infrastructure data and one or more insights using the LLM; and
generating the one or more adaptive security posture recommendations that are broken into one or more simple insights for adapting the one or more adaptive security posture recommendations to be understandable for the one or more users.

19. The non-transitory computer-readable storage medium of claim 15, further comprising automatically learning from one or more remediation actions and telemetry data to continuously refine the one or more adaptive security posture recommendations for improving accuracy of the LLM over time, by:
collecting the one or more remediation actions taken by the one or more users in response to the one or more adaptive security posture recommendations; wherein the one or more remediation actions comprise at least one of: one or more steps taken to address detected security issues, compliance gaps, and misconfigurations within at least one of: the one or more cloud infrastructures and the one or more application infrastructures;
continuously collecting the telemetry data from at least one of: the one or more cloud infrastructures and the one or more application infrastructures, wherein the telemetry data comprises at least one of: real-time operational metrics, security events, configuration changes, and performance indicators associated with the one or more infrastructure components;
analyzing effectiveness of the one or more remediation actions by correlating the one or more remediation actions with subsequent changes in the telemetry data, wherein the analysis determines whether the one or more remediation actions successfully resolved the detected security issues and improved the overall one or more security posture recommendations;
identifying one or more patterns and correlations between one or more specific remediation actions and outcomes of the one or more specific remediation actions, wherein the one or more patterns indicate which remediation strategies are optimized effective for specific types of security vulnerabilities, compliance gaps, and infrastructure configurations;
updating the LLM using the identified one or more patterns and correlations, wherein the LLM is updated to incorporate one or more learned insights, adapting the generation of accurate and context-aware one or more adaptive security posture recommendations;
continuously refining the one or more adaptive security posture recommendations based on the accumulated learning of the LLM, wherein the refined one or more adaptive security posture recommendations possess improved accuracy, relevance, and effectiveness in addressing security risks and determining compliance with the one or more industry standards; and
identifying refining by reinforcement learning that optimizes a result by taking user feedback and codifying at least one of: self-learning and reinforcement learning into knowledge, for analyzing the effectiveness of the one or more remediation actions.

20. The non-transitory computer-readable storage medium of claim 15, further comprising simulating and predicting the security risks and potential compliance gaps based on dynamic infrastructure changes, by:
creating one or more virtual representations of proposed modifications to the one or more infrastructure components, comprising adding one or more new cloud services, changing configurations, modifying access permissions, and updating the dependencies;
analyzing the one or more dynamic knowledge graphs to determine how the proposed modifications affect the one or more relationships and dependencies between the one or more infrastructure components, identifying one or more potential new vulnerabilities;
assessing multi-hop impact by determining whether the proposed modifications to the one or more infrastructure components result in deviations from the one or more industry standards comprising internal standards and baseline, for identifying the potential compliance gaps before an occurrence of the proposed modifications; and
remediating with proactive one or more dynamic security posture recommendations to mitigate identified security risks, adapting the one or more organizations, based on simulation assessments, to make informed decisions about infrastructure changes and implement preventive measures.
